(19) United States
(12) Patent Application Publication
(10) Pub. No.: US 2013/0215993 A1
(43) Pub. Date: Aug. 22, 2013

(54) SYSTEMS AND METHODS FOR DETECTING TRANSMISSIONS BASED ON 32-POINT AND 64-POINT FAST FOURIER TRANSFORMS

(71) Applicants: Mohammad Hossein Taghavi Nasrabadi, San Diego, CA (US); Sameer Vermani, San Diego, CA (US)

(72) Inventors: Mohammad Hossein Taghavi Nasrabadi, San Diego, CA (US); Sameer Vermani, San Diego, CA (US)

(73) Assignee: QUALCOMM Incorporated, San Diego, CA (US)

(21) Appl. No.: 13/588,541

(22) Filed: Aug. 17, 2012

Related U.S. Application Data
(60) Provisional application No. 61/526,762, filed on Aug. 24, 2011.

(51) Int. Cl. H04L 27/26

(52) U.S. Cl. CPC H04L 27/2601
USPC 375/295; 375/343

(57) ABSTRACT

Systems, methods, and devices for communicating and detecting training sequences are described herein. In one aspect, a method of wireless communication is provided. The method comprises receiving one or more short training field (STF) sequences comprising sixty-four values or less. The STF sequences comprise zero and non-zero values. The non-zero values are located at one or more indices of the STF that are separated by a multiple of at least four. The method further comprises determining a first correlation between the STF and the STF shifted by a first shift length. The method further comprises determining a second correlation between the STF and the STF shifted by a second shift length. The method further comprises determining a fast Fourier transform (FFT) size based on the first correlation and the second correlation. The method further comprises decoding one or more data symbols based at least in part on the determined FFT size.

### CROSS-REFERENCE TO RELATED APPLICATIONS

The present application claims priority benefit under 35 U.S.C. §119(e) to U.S. Provisional Patent Application Ser. No. 61/526,762, filed Aug. 24, 2011, the entire contents of which are incorporated by reference and should be considered a part of this specification.

### BACKGROUND

1. Field

The present application relates generally to wireless communications, and more specifically to systems, methods, and devices for communicating training fields. Certain aspects herein relate to determining training sequences for use with a thirty-two and sixty-four point fast Fourier transform (FFT), and detecting the same.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. The packets may include overhead information (e.g., header information, packet properties, etc.) that helps in routing the packet through the network, identifying the data in the packet, processing the packet, etc., as well as data, for example user data, multimedia content, etc. as might be carried in a payload of the packet.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include decreasing the overhead in transmitting payloads in data packets.

One aspect of the disclosure provides a method of wireless communication. The method comprises receiving one or more short training field (STF) sequences comprising sixty-four values or less. The STF sequences comprise zero and non-zero values. The non-zero values are located at one or more indices of the STF that are separated by a multiple of at least four. The method further comprises determining a first correlation between the STF and the STF shifted by a first shift length. The method further comprises determining a second correlation between the STF and the STF shifted by a second shift length. The method further comprises determining a fast Fourier transform (FFT) size based on the first correlation and the second correlation. The method further comprises decoding one or more data symbols based at least in part on the determined FFT size.

Another aspect of the disclosure provides a method of wireless communication. The method comprises generating one or more short training field (STF) sequences comprising sixty-four values or less. The STF sequences comprise zero and non-zero values, and the non-zero values are located at one or more indices of the first subset that are separated by a multiple of eight. The method further comprises transmitting a data unit comprising the one or more STF sequences over a wireless channel.

Another aspect of the disclosure provides a wireless device. The wireless device comprises a receiver configured to receive one or more short training field (STF) sequences. The STF sequences comprise sixty-four values or less. The STF sequences comprise zero and non-zero values, and the non-zero values are located at one or more indices of the STF that are separated by a multiple of at least four. The wireless device further comprises a processor configured to determine a first correlation between the STF and the STF shifted by a first shift length. The processor is further configured to determine a second correlation between the STF and the STF shifted by a second shift length. The processor is further configured to determine a fast Fourier transform (FFT) size based on the first correlation and the second correlation. The processor is further configured to decode one or more data symbols based at least in part on the determined FFT size.

Another aspect of the disclosure provides a wireless device. The wireless device comprises a processor configured to generate one or more short training field (STF) sequences. The STF sequences comprise sixty-four values or less. The STF sequences comprise zero and non-zero values, and the non-zero values are located at one or more indices of the STF that are separated by a multiple of at least four. The wireless device further comprises a transmitter configured to transmit a data unit comprising the one or more STF sequences over a wireless channel.

Another aspect of the disclosure provides an apparatus for wireless communication. The apparatus comprises means for receiving one or more short training field (STF) sequences. The STF sequences comprise sixty-four values or less. The STF sequences comprise zero and non-zero values, and the non-zero values are located at one or more indices of the STF that are separated by a multiple of at least four. The apparatus further comprises means for determining a first correlation between the STF and the STF shifted by a first shift length. The apparatus further comprises means for determining a second correlation between the STF and the STF shifted by a second shift length. The apparatus further comprises means for determining a fast Fourier transform (FFT) size based on the first correlation and the second correlation. The apparatus further comprises means for decoding one or more data symbols based at least in part on the determined FFT size.

Another aspect of the disclosure provides an apparatus for wireless communication. The apparatus comprises means for generating one or more short training field (STF) sequences. The STF sequences comprise sixty-four values or less. The STF sequences comprise zero and non-zero values, and the non-zero values are located at one or more indices of the STF that are separated by a multiple of at least four. The apparatus further comprises means for transmitting a data unit comprising the one or more STF sequences over a wireless channel.

Another aspect of the disclosure provides a non-transitory computer-readable medium. The medium comprises code that, when executed, causes an apparatus to receive one or more short training field (STF) sequences. The STF sequences comprise sixty-four values or less. The STF sequences comprise zero and non-zero values, and the non-zero values are located at one or more indices of the STF that are separated by a multiple of at least four. The medium further comprises code that, when executed, causes the apparatus to determine a first correlation between the STF and the STF shifted by a first shift length. The medium further comprises code that, when executed, causes the apparatus to determine a second correlation between the STF and the STF shifted by a second shift length. The medium further comprises code that, when executed, causes the apparatus to determine a fast Fourier transform (FFT) size based on the first correlation and the second correlation. The medium further comprises code that, when executed, causes the apparatus to decode one or more data symbols based at least in part on the determined FFT size.

Another aspect of the disclosure provides a non-transitory computer-readable medium. The medium comprises code that, when executed, causes an apparatus to generate one or more short training field (STF) sequences. The STF sequences comprise sixty-four values or less. The STF sequences comprise zero and non-zero values, and the non-zero values are located at one or more indices of the STF that are separated by a multiple of at least four. The medium further comprises code that, when executed, causes the apparatus to transmit a data unit comprising the one or more STF sequences over a wireless channel.

### BRIEF DESCRIPTION OF THE DRAWINGS

FIG. 1 illustrates an example of a wireless communication system in which aspects of the present disclosure may be employed.

FIG. 2 shows a functional block diagram of an exemplary wireless device that may be employed within the wireless communication system of FIG. 1.

FIG. 3 shows a functional block diagram of exemplary components that may be utilized in the wireless device of FIG. 2 to transmit wireless communications.

FIG. 4 shows a functional block diagram of exemplary components that may be utilized in the wireless device of FIG. 2 to receive wireless communications.

FIG. 5 illustrates an example of a physical layer data unit.

FIG. 6 shows a table listing various exemplary allocations of different types of subcarriers for 32 subcarriers along with a potential position of the pilot subcarriers.

FIG. 7 shows a functional block diagram of exemplary components that may be utilized in the packet detector of FIG. 4.

FIG. 8 shows a flowchart of an aspect of an exemplary method for generating and transmitting a data unit.

FIG. 9 shows a flowchart of another aspect of an exemplary method for receiving and processing a data unit including a training sequence.

FIG. 10 is a functional block diagram of another exemplary wireless device that may be employed within the wireless communication system of FIG. 1.

FIG. 11 is a functional block diagram of yet another exemplary wireless device that may be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

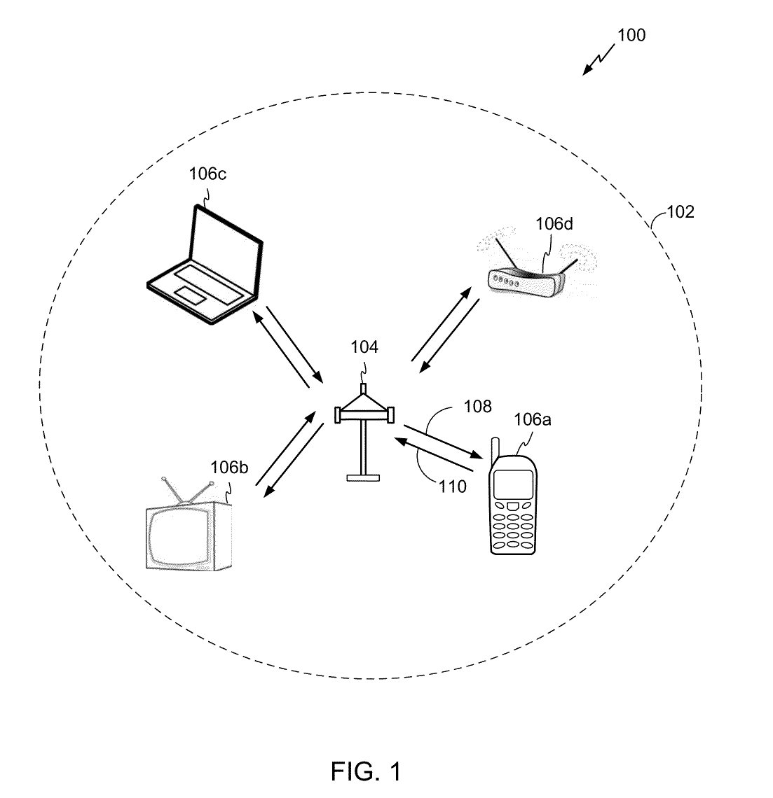

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

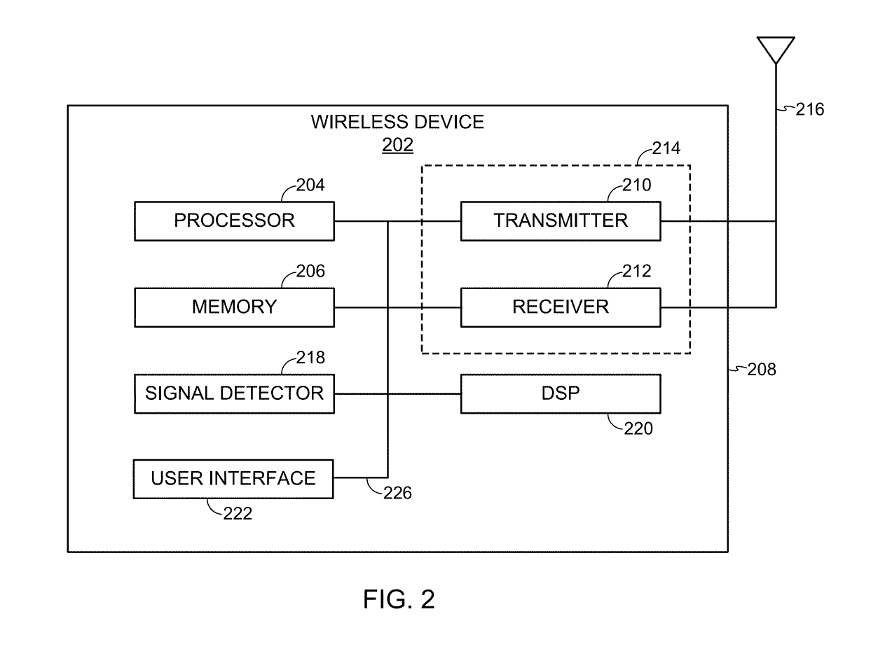

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

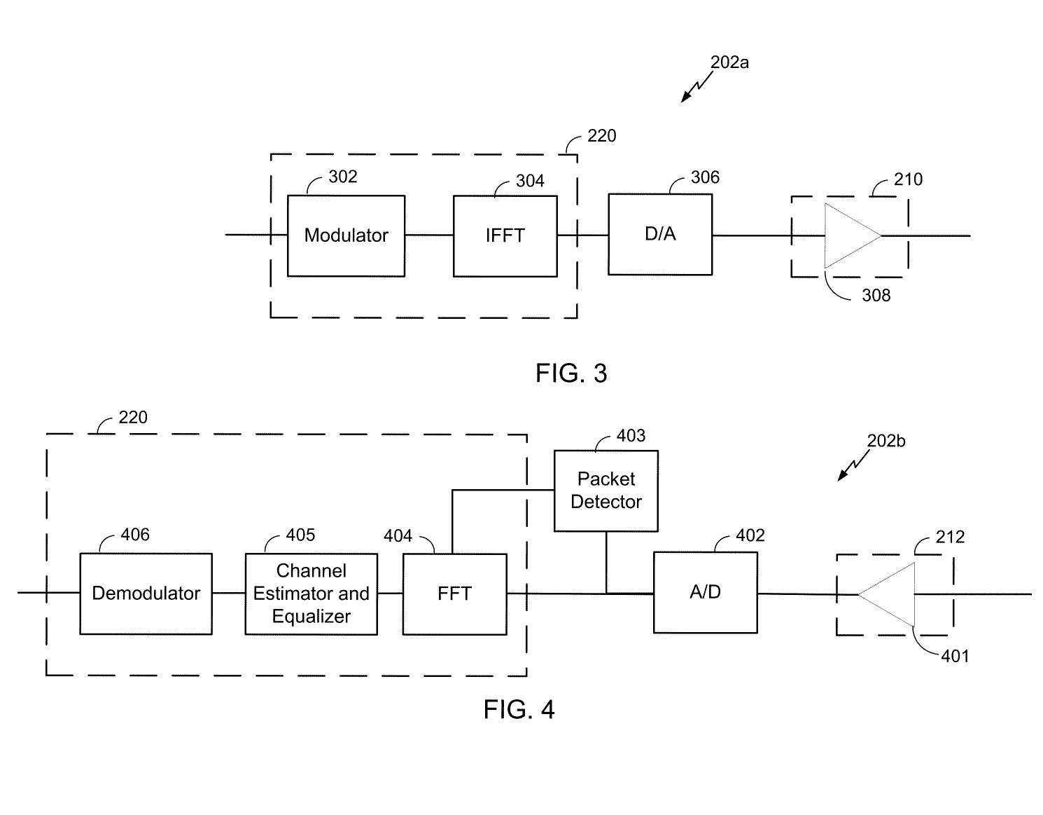

As discussed above, the wireless device 202 may comprise an AP 104 or an STA 106, and may be used to transmit and/or receive communications. FIG. 3 illustrates various components that may be utilized in the wireless device 202 to transmit wireless communications. The components illustrated in FIG. 3 may be used, for example, to transmit OFDM communications. In some aspects, the components illustrated in FIG. 3 are used to transmit data units with training fields with peak-to-average power ratio is as low as possible, as will be discussed in additional detail below. For ease of reference, the wireless device 202 configured with the components illustrated in FIG. 3 is hereinafter referred to as a wireless device 202a.

The wireless device 202a may comprise a modulator 302 configured to modulate bits for transmission. For example, the modulator 302 may determine a plurality of symbols from bits received from the processor 204 or the user interface 222, for example by mapping bits to a plurality of symbols according to a constellation. The bits may correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The wireless device 202a may further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there may be multiple transform modules (not shown) that transform units of data of different sizes.

In FIG. 3, the modulator 302 and the transform module 304 are illustrated as being implemented in the DSP 220. In some aspects, however, one or both of the modulator 302 and the transform module 304 are implemented in the processor 204 or in another element of the wireless device 202.

As discussed above, the DSP 220 may be configured to generate a data unit for transmission. In some aspects, the modulator 302 and the transform module 304 may be configured to generate a data unit comprising a plurality of fields including control information and a plurality of data symbols. The fields including the control information may comprise one or more training fields, for example, and one or more signal (SIG) fields. Each of the training fields may include a known sequence of bits or symbols. Each of the SIG fields may include information about the data unit, for example a description of a length or data rate of the data unit.

Returning to the description of FIG. 3, the wireless device 202a may further comprise a digital to analog converter (DAC) 306 configured to convert the output of the transform module into an analog signal. For example, the time-domain output of the transform module 306 may be converted to a baseband OFDM signal by the digital to analog converter 306. The digital to analog converter 306 may be implemented in the processor 204 or in another element of the wireless device 202. In some aspects, the digital to analog converter 306 is implemented in the transceiver 214 or in a data transmit processor.

The analog signal may be wirelessly transmitted by the transmitter 210. The analog signal may be further processed before being transmitted by the transmitter 210, for example by being filtered or by being upconverted to an intermediate or carrier frequency. In the aspect illustrated in FIG. 3, the transmitter 210 includes a transmit amplifier 308. Prior to being transmitted, the analog signal may be amplified by the transmit amplifier 308. In some aspects, the amplifier 308 comprises a low noise amplifier (LNA).

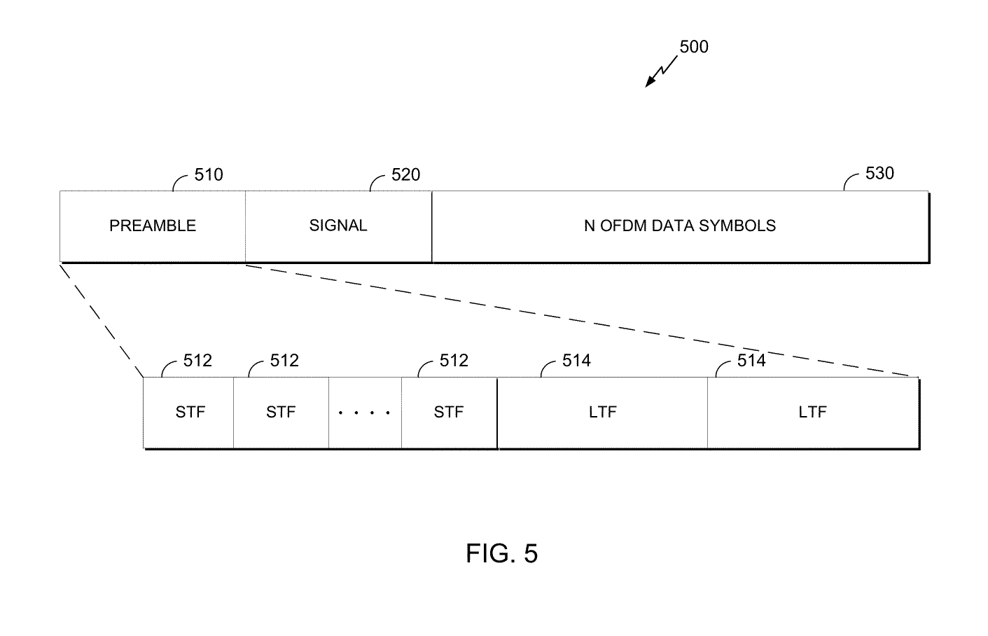

The transmitter 210 is configured to transmit one or more packets or data units in a wireless signal based on the analog signal. The data units may be generated using the processor 204 and/or the DSP 220, for example using the modulator 302 and the transform module 304 as discussed above. Data units that may be generated and transmitted as discussed above are described in additional detail below with respect to FIGS. 5-10.

FIG. 4 illustrates various components that may be utilized in the wireless device 202 to receive wireless communications. The components illustrated in FIG. 4 may be used, for example, to receive OFDM communications. In some aspects, the components illustrated in FIG. 4 are used to receive data units that include one or more training fields, as will be discussed in additional detail below. For example, the components illustrated in FIG. 4 may be used to receive data units transmitted by the components discussed above with respect to FIG. 3. For ease of reference, the wireless device 202 configured with the components illustrated in FIG. 4 is hereinafter referred to as a wireless device 202b.

The receiver 212 is configured to receive one or more packets or data units in a wireless signal. Data units that may be received and decoded or otherwise processed as discussed below are described in additional detail with respect to FIGS. 5-12.

In the aspect illustrated in FIG. 4, the receiver 212 includes a receive amplifier 401. The receive amplifier 401 may be configured to amplify the wireless signal received by the receiver 212. In some aspects, the receiver 212 is configured to adjust the gain of the receive amplifier 401 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 401 comprises an LNA.

The wireless device 202b may comprise an analog to digital converter 402 configured to convert the amplified wireless signal from the receiver 212 into a digital representation thereof. Further to being amplified, the wireless signal may be processed before being converted by the digital to analog converter 402, for example by being filtered or by being downconverted to an intermediate or baseband frequency. The analog to digital converter 402 may be implemented in the processor 204 or in another element of the wireless device 202. In some aspects, the analog to digital converter 402 is implemented in the transceiver 214 or in a data receive processor.

The wireless device 202b may further comprise a packet detector 403 configured to detect an incoming packet. The packet detector 403 may detect an incoming packet based on information in the STF. In an aspect, the packet detector 403 may use auto-correlation of the STF, based on one or more shift values, in order to detect a packet. Moreover, the packet detector 403 may detect an FFT mode of the packet, and relay the detected FFT mode to a transform module 404. In various aspects, the packet detector 403 may be implemented by the processor 204, the DSP 220, the signal detector 218, or other hardware or software.

The wireless device 202b may further comprise a transform module 404 configured to convert the representation the wireless signal into a frequency spectrum. In FIG. 4, the transform module 404 is illustrated as being implemented by a fast Fourier transform (FFT) module. The transform module 404 may be programmable, and may be configured to perform FFT with different configurations based on a signal received from the packet detector 403. In one aspect, for example, the transform module 404 may be configured to perform either a 32-point FFT or a 64-point FFT based on an FFT mode received from the packet detector 403. In some aspects, the transform module may identify a symbol for each point that it uses.

The wireless device 202b may further comprise a channel estimator and equalizer 405 configured to form an estimate of the channel over which the data unit is received, and to remove certain effects of the channel based on the channel estimate. For example, the channel estimator may be configured to approximate a function of the channel, and the channel equalizer may be configured to apply an inverse of that function to the data in the frequency spectrum.

In some aspects, the channel estimator and equalizer 405 uses information in one or more received training fields, such as a long training field (LTF) for example, to estimate the channel. The channel estimate may be formed based on one or more LTFs received at the beginning of the data unit. This channel estimate may thereafter be used to equalize data symbols that follow the one or more LTFs. After a certain period of time or after a certain number of data symbols, one or more additional LTFs may be received in the data unit. The channel estimate may be updated or a new estimate formed using the additional LTFs. This new or update channel estimate may be used to equalize data symbols that follow the additional LTFs. In some aspects, the new or updated channel estimate is used to re-equalize data symbols preceding the additional LTFs. Those having ordinary skill in the art will understand methods for forming a channel estimate.

The wireless device 202b may further comprise a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. The bits may be processed or evaluated by the processor 204, or used to display or otherwise output information to the user interface 222. In this way, data and/or information may be decoded. In some aspects, the bits correspond to codewords. In one aspect, the demodulator 406 comprises a QAM (quadrature amplitude modulation) demodulator, for example a 16-QAM demodulator or a 64-QAM demodulator. In other aspects, the demodulator 406 comprises a binary phase-shift keying (BPSK) demodulator or a quadrature phase-shift keying (QPSK) demodulator.

In FIG. 4, the transform module 404, the channel estimator and equalizer 405, and the demodulator 406 are illustrated as being implemented in the DSP 220. In some aspects, however, one or more of the transform module 404, the channel estimator and equalizer 405, and the demodulator 406 are implemented in the processor 204 or in another element of the wireless device 202.

As discussed above, the wireless signal received at the receiver 212 comprises one or more data units. Using the functions or components described above, the data units or data symbols therein may be decoded evaluated or otherwise evaluated or processed. For example, the processor 204 and/or the DSP 220 may be used to decode data symbols in the data units using the transform module 404, the channel estimator and equalizer 405, and the demodulator 406.

Data units exchanged by the AP 104 and the STA 106 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

FIG. 5 illustrates an example of a data unit 500. The data unit 500 may comprise a PPDU for use with the wireless device 202. The data unit 500 may be used by legacy devices or devices implementing a legacy standard or downclocked version thereof.

The data unit 500 includes a preamble 510. The preamble 510 may comprise a variable number of repeating STF 512 symbols, and one or more LTF 514 symbols. In one implementation 10 repeated STF 512 symbols may be set followed by two LTF 512 symbols. The STF 512 may be used by the receiver 212 to perform automatic gain control to adjust the gain of the receive amplifier 401, as discussed above. Furthermore, the STF 512 sequence may be used by the receiver 212 for packet detection (for example, by the packet detector 403), rough timing, and other settings. The LTF 514 may be used by the channel estimator and equalizer 405 to form an estimate of the channel over which the data unit 500 is received.

Following the preamble 510 in the data unit 500 is a SIGNAL unit 520. The SIGNAL may be one OFDM signal that includes various information relating to the transmission rate, the length of the data unit 500, and the like. The data unit 500 additionally includes a variable number of data symbols 530, such as OFDM data symbols.

When the data unit 500 is received at the wireless device 202b, the size of the data unit 500 including the training symbols 514 may be computed based on the SIGNAL field 520, and the STF 512 may be used by the receiver 212 to adjust the gain of the receive amplifier 401. Further, a LTF 514a may be used by the channel estimator and equalizer 405 to form an estimate of the channel over which the data unit 500 is received. The channel estimate may be used by the processor 220 to decode the plurality of data symbols 522 that follow the preamble 510.

The data unit 500 illustrated in FIG. 5 is only an example of a data unit that may be used in the system 100 and/or with the wireless device 202. Those having ordinary skill in the art will appreciate that a greater or fewer number of the STFs 412 or LTFs 514 and/or the data symbols 530 may be included in the data unit 500. In addition, one or more symbols or fields may be included in the data unit 500 that are not illustrated in FIG. 5, and one or more of the illustrated fields or symbols may be omitted.

When using OFDM, information using a number of orthogonal subcarriers of the frequency band being used. The number of subcarriers that are used may depend on a variety of considerations including the available frequency bands for use, bandwidth and any associated regulatory constraints. The number of subcarriers used is correlated to the size of an FFT module as each modulated subcarrier is an input to an IFFT module to create the OFDM signal to be transmitted. As such, in some implementations a larger FFT size (e.g., 64, 128, 256, 512, etc.) may, corresponding to transmitting data using more subcarriers, be desired to achieve a larger bandwidth. In other implementations, a smaller FFT size may be used for transmitting data in a narrow bandwidth. The number of subcarriers, and therefore FFT size, may be chosen so as to comply with regulatory domains with certain bandwidth restrictions. For example, an FFT size of 32 may be provided for certain implementations (e.g., for down clocked implementations), and provided for use for 802.11ah. As such, the wireless device 202a may include a several transform modules 304 implemented as an FFT or IFFT module, each of different sizes so as to comply with the number of subcarriers specified to be used. At least one of the transform modules 304 may be a 32-point size IFFT or FFT module according to certain aspects described herein. In an embodiment, the transform module 304 may be configured to selectively perform FFT in a plurality of different sizes based on a detected FFT mode. In an aspect, a multi-mode transform module may include a plurality of FFT modules, each configured to use different FFT sizes, the output of each of which may be selected based on a detected FFT mode.

The number of subcarriers may be characterized by a spectral line used to map the subcarriers to indices for identifying each subcarrier. The spectral line may define indices that span a negative and positive range where half of the subcarriers are represented on each of the negative and positive ranges. For example, for 64 subcarriers, each subcarrier may be mapped to indices from −32 to 31 to define the spectral line. When using 32 subcarriers (i.e., tones), the spectral line may defined to map each subcarrier to indices from −16 to 15.

The number of subcarriers used and therefore FFT size may determine the size of the training sequence such as the STF 512 and LTF 514 transmitted as described above. Each signal sent, and therefore training sequence may be characterized by its peak-to-average power ratio (PAPR). The PAPR may be generally defined as the peak amplitude of OFDM signal divided by the root mean square of the amplitudes OFDM signal. For example, an OFDM signal may be expressed as:

$$x ( t ) = {\sum }_{k = 0}^{N - 1} {X}_{k} {e}^{j \frac{2 π kt}{T}}$$

where Xₖ represent data symbols, N are the number of subcarriers, and T is time for the OFDM symbol. The PAPR may be calculated as:

$$PAPR = \frac{max {\vert x ( t ) \vert}^{2}}{E [ {\vert x ( t ) \vert}^{2} ]}$$

where E defines a function for the mean square value of the signal.

As an OFDM signal may be a combination of a large number of signals each with different amplitudes, a PAPR value for the signal may be fairly large. A high PAPR may result in distortion of the signal and other problems, for example, if the signal passes through nonlinear components, such as a power amplifier 308. This signal distortion may result in increased noise and interference between subcarriers. Furthermore, a low PAPR may avoid clipping the signal. As such it may be beneficial to reduce the PAPR of each OFDM signal when possible. More importantly, as each training sequence is used to synchronize the OFDM signal at the receiver, any added distortion in the training sequence may make synchronization particularly problematic. As such, it may be desirable to minimize the PAPR for a training sequence in order to minimize distortion and ensure accurate synchronization with a receiver for transmitting information. As such, certain aspects of the disclosure are directed to generating training field sequences with minimal PAPR values.

The training sequence size may correspond to the number of subcarriers and therefore FFT size used to transmit the signal. As such, for a 32-point FFT, each training sequence may include 32 values. Accordingly, determining a 32 value sequence with a minimal PAPR may be beneficial for preventing distortion of the training sequence. Each subcarrier may be mapped for different types for transmission that may include guard subcarriers (with a value of zero), direct current (DC) subcarriers, pilot subcarriers, and data subcarriers. As described above, a spectral line for identifying subcarriers for 32 subcarriers may be defined from −16 to 15. The DC subcarrier may be located at an index for generating a zero mean signal. As such one or more DC subcarriers may be located at indexes of −1, 0, and +1 in the spectral line for generating a zero mean signal with three DC tones. For example, in the sequences described below, if using one DC subcarrier, it may be located at the 0 index. Guard subcarriers may be positioned at the most negative subcarrier indices and the most positive subcarrier indices in the spectral line (e.g., for 3 guard subcarriers using a spectral line of −16 to 15, the guard subcarriers may be located at indices of −16, −15, and +15. The number of each type of subcarriers and the position of the subcarrier type may determine sequence values and therefore impact the PAPR.

It should be appreciated that while an OFDM symbol may be transmitted using a number of subcarriers, various implementations may use oversampling in the IFFT operation to produce the resulting OFDM signal. As such, if 64 subcarriers are used, a 256 IFFT may be used to generate the signal for four times oversampling. In addition, if OFDM symbols are transmitted using 32 subcarriers, the OFDM signal may be produced via a 128 point IFFT four times oversampling. Accordingly the training sequences described below may correspond to sequences with low PAPR when using a four times sampled IFFT.

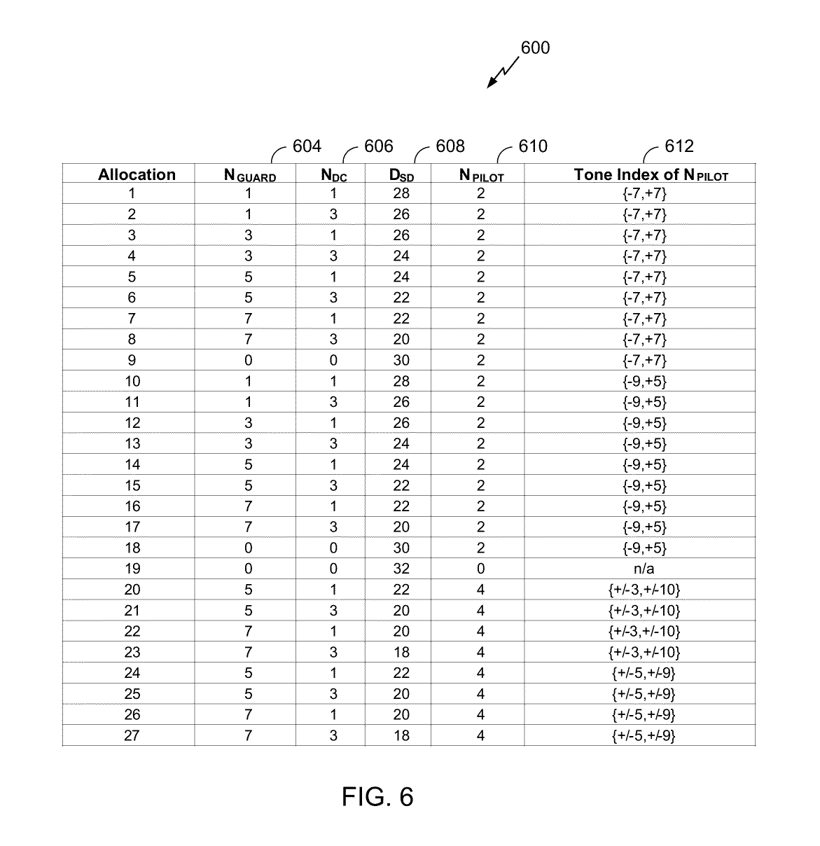

FIG. 6 shows a table 600 listing various exemplary allocations of different types of subcarriers for 32 subcarriers along with a potential position of the pilot subcarriers 610. The spectral line for each allocation is from −16:15. For example, according to allocation 1, each OFDM signal may be transmitted with 1 guard subcarrier 604, 1 DC subcarrier 606, 28 data subcarriers 608, and 2 pilot subcarriers 610 and where the subcarriers index of the pilot subcarriers 612 are at {−7:−7} According to another allocation 7, each OFDM signal may be transmitted with 7 guard subcarriers 604, 1 DC subcarrier 606, 22 data subcarriers 608, and 2 pilot subcarriers 610, where the tone index of the pilot subcarriers 612 are at {−7:−7}. The training sequence for each possible allocation of subcarriers may therefore be different depending on the number of each type of subcarrier and potential values that are chosen to be used in the training sequence.

According to one embodiment, short training fields 512 may be determined for allocation 5 of FIG. 6 with reduced PAPR. In the fifth sub-carrier allocation, there are 5 guard subcarriers 604, 1 DC subcarrier 606, 2 pilot subcarriers 610 at {−7,+7}, and 24 data subcarriers, and 612. For the STF sequence, the subcarriers corresponding to the guard subcarriers and DC subcarrier may be modulated with a value of zero. The position of the guard subcarriers may be divided and be at the beginning and the end of the spectral line of subcarriers. As such, the STF sequence 512 would have zero values for each of the guard subcarriers and DC subcarriers, with zero values for the guard subcarriers at the beginning and end. A limited number of data or pilot subcarriers for the STF sequence 512 are chosen to be modulated with non-zero values. The spectral lines described below may refer to the spectral line with guard subcarriers which are located the beginning and end of the spectral lines. As such the spectral lines below may refer to the spectral line of data and pilot subcarriers with a DC subcarrier at the 0 index (e.g., middle) of the spectral line. For example, for the fifth allocation of FIG. 6, the spectral line without guard subcarriers may be defined with indices from −13 to 13 as three guard carriers may lead the sequence and 2 guard carriers may trail the sequence. To achieve a low PAPR, the values for modulating the non-zero value subcarriers may be chosen from:

$$\{ {e}^{\pm j \frac{π}{4}} = \pm \sqrt{\frac{1}{2}} ( 1 + j ) \}$$

and may correspond to indices that are a multiple of 4 in the spectral line of S_{-13:13}. The two values of \sqrt{½}(1+j) and \sqrt{½}(−1−j) may correspond to values that provide improved correlation for the detection of the presence of a packet while also additionally providing a value to allow a reduced PAPR for the STF sequence 512. Repeating non-zero values (e.g., ensuring the sequence has periodicity) and ensuring that there are an equal number of non-zero values on each side of the DC value provides good correlation and helps with packet detection. The values in Table 1 below shows short training sequences 512, according to certain embodiments, that have been determined to have low PAPR values using the choice of symbols as just described according to the fifth subcarrier allocation shown in FIG. 6.

TABLE 1

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j, 0} | 2.2303 dB |
| \sqrt{1/2} {0, −1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j, 0} | 2.2303 dB |
| \sqrt{1/2} {0, 1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j, 0} | 2.2303 dB |
| \sqrt{1/2} {0, −1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j, 0} | 2.2303 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j, 0} | 3.3095 dB |
| \sqrt{1/2} {0, 1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j, 0} | 3.3095 dB |
| \sqrt{1/2} {0, −1 − j, 0, 0, 0, 1 + j, 0, 0, 0, 1 + j0, 0, 0, 0, 0, 0, 0, 1 + j, 0, 0, 0, −1 − j, 0, 0, 0, −1 − j, 0} | 3.3095 dB |
| \sqrt{1/2} {0, −1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j, 0} | 3.3095 dB |
| \sqrt{1/2} {0, 1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j, 0} | 4.2597 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j, 0} | 4.2597 dB |

Accordingly, these STF sequences may correspond to optimally low PAPR values that may avoid distorting the short training sequence when transmitted while having good correlation properties for packet detection for the fifth allocation shown in FIG. 6. These sequences may correspond to training sequence with low PAPR values when using a four times oversampled IFFT.

According to another embodiment, a different mode might be used to extend range (e.g., for Medium—XR mode)). Rather than having a non-zero value at multiples of four indices of the spectral line, every other data or pilot subcarrier may be modulated with a non-zero value such as either \sqrt{½}(1+j) or \sqrt{½}(−1−j) as described above. As such the non-zero subcarriers may have indices of a multiple of 2 in spectral lines of M_{-13:13}. The values in Table 2 below show short training sequences 512, according to certain embodiments, that have been determined to have low PAPR values using the choice of symbols as just described for the extended range mode using the fifth allocation of FIG. 6.

TABLE 2

| M_{-13:13} | PAPR |
|---|---|
| \sqrt{1/2} {0, 1 + j, 0, 1 + j, 0, 1 + j, 0, −1 − j, 0, −1 − j, 0, −1 − j, 0, 0, 0, −1 − j, 0, 1 + j, 0, −1 − j, 0, | 2.0589 dB |
| −1 − j, 0, 1 + j, 0, −1 − j, 0} | |
| \sqrt{1/2} {0, 1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j, 0} | |
| \sqrt{1/2} {0, −1 − j, 0, 1 + j, 0, −1 − j, 0, −1 − j, 0, 1 + j, 0, −1 − j, 0, 0, 0, −1 − j, 0, −1 − j, 0, −1 − j, 0, | 2.0589 dB |
| 1 + j, 0, 1 + j, 0, 1 + j, 0} | |
| \sqrt{1/2} {0, −1 − j, 0, −1 − j, 0, −1 − j, 0, 1 + j, 0, 1 + j, 0, 1 + j, 0, 0, 0, 1 + j, 0, −1 − j, 0, 1 + j, 0, | 2.0589 dB |
| 1 + j, 0, −1 − j, 0, 1 + j, 0} | |
| \sqrt{1/2} {0, 1 + j, 0, 1 + j, 0, 1 + j, 0, 1 + j, 0, −1 − j, 0, −1 − j, 0, 0, 0, 1 + j, 0, −1 − j, 0, −1 − j, 0, | 2.2394 dB |
| 1 + j, 0, −1 − j, 0, 1 + j, 0} | |
| \sqrt{1/2} {0, 1 + j, 0, −1 − j, 0, 1 + j, 0, −1 − j, 0, −1 − j, 0, 1 + j, 0, 0, 0, −1 − j, 0, −1 − j, 0, 1 + j, 0, | 2.2394 dB |
| 1 + j, 0, 1 + j, 0, 1 + j, 0} | |
| \sqrt{1/2} {0, −1 − j, 0, 1 + j, 0, −1 − j, 0, 1 + j, 0, 1 + j, 0, −1 − j, 0, 0, 0, 1 + j, 0, 1 + j, 0, −1 − j, 0, | 2.2394 dB |
| −1 − j, 0, −1 − j, 0, −1 − j, 0} | |
| \sqrt{1/2} {0, −1 − j, 0, −1 − j, 0, −1 − j, 0, −1 − j, 0, 1 + j, 0, 1 + j, 0, 0, 0, −1 − j, 0, 1 + j, 0, 1 + j, 0, | 2.2394 dB |
| −1 − j, 0, 1 + j, 0, −1 − j, 0} | |
| \sqrt{1/2} {0, 1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, | 2.2974 dB |
| 0, −1 − j, 0, 1 + j, 0} | |
| \sqrt{1/2} {0, −1 − j, 0, −1 − j, 0, −1 − j, 0, −1 − j, 0, −1 − j, 0, 1 + j, 0, 0, 0, 1 + j, 0, −1 − j, 0, −1 − j, 0, | 2.2974 dB |
| 1 + j, 0, 1 + j, 0, −1 − j, 0} | |

Accordingly, these STF sequences 512 may correspond to optimally low PAPR values for the fifth allocation shown in FIG. 6 when using an extended range mode. The sequences may correspond to training sequence with low PAPR values when using a four times oversampled IFFT.

According to another embodiment, LTF sequences 514 may be determined for the fifth allocation shown in FIG. 6 that have low PAPR values. For an LTF sequence, every subcarrier corresponding to a data subcarrier or a pilot subcarrier may be modulated with a non-zero symbol. To achieve a low PAPR, all the data and pilot symbol values may be chosen from either +1 or −1, and selected so as to minimize the PAPR ratio. The values in Table 3 below shows LTF sequences 512, according to certain embodiments, that have been determined to have low PAPR values using the choice of symbols as just described according to the fifth subcarrier allocation shown in FIG. 6 for the spectral line of −13:13.

TABLE 3

| LTF_{-13:13} | PAPR |
|---|---|
| {1, −1, 1, 1, −1, 1, 1, −1, 1, 1, 1, −1, 1, 0, −1, −1, −1, 1, −1, −1, −1, 1, 1, 1, −1, −1, −1} | 1.8365 dB |
| {1, −1, 1, −1, 1, −1, −1, 1, −1, −1, 1, 1, −1, 0, −1, −1, 1, 1, −1, −1, −1, 1, 1, 1, 1, 1, 1} | 1.9942 dB |
| {1, −1, 1, −1, 1, −1, 1, 1, −1, −1, −1, 1, 1, 0, 1, −1, −1, 1, −1, −1, 1, 1, 1, 1, 1, 1, 1} | 2.0381 dB |
| {1, −1, 1, −1, 1, 1, 1, 1, 1, 1, 1, 1, −1, 0, −1, −1, 1, −1, 1, 1, −1, −1, 1, 1, −1, −1, 1} | 2.2113 dB |
| {1, −1, 1, −1, 1, −1, −1, 1, 1, 1, −1, −1, 1, 0, 1, 1, −1, −1, 1, −1, −1, 1, 1, 1, 1, 1, 1} | 2.3083 dB |
| {1, 1, 1, −1, 1, −1, −1, −1, 1, 1, 1, 1, −1, 0, 1, 1, −1, 1, −1, −1, 1, −1, −1, −1, −1, 1, −1} | 2.3087 dB |
| {1, 1, 1, 1, 1, 1, 1, −1, −1, 1, −1, 1, −1, 0, −1, 1, 1, 1, −1, −1, −1, 1, 1, −1, 1, 1, −1} | 2.3140 dB |
| {1, 1, 1, 1, 1, −1, −1, −1, −1, −1, 1, −1, −1, 0, 1, −1, −1, −1, 1, −1, 1, −1, −1, 1, −1, 1, −1} | 2.3579 dB |
| {1, −1, −1, 1, 1, −1, −1, 1, −1, −1, 1, −1, 1, 0, 1, 1, 1, 1, 1, 1, 1, −1, −1, −1, 1, 1, 1} | 2.3622 dB |
| {1, 1, −1, −1, −1, −1, 1, 1, 1, 1, −1, 1, −1, 0, −1, 1, −1, −1, −1, 1, −1, −1, −1, −1, 1, −1, −1} | 2.3983 dB |

Accordingly, these LTF sequences 514 may correspond to optimally low PAPR values for the fifth allocation shown in FIG. 6. The sequences may correspond to training sequence with low PAPR values when using a four times oversampled IFFT.

The LTF field may provide a mechanism for a receiver to estimate a MIMO channel and provides training for space time streams. Accordingly, to another embodiment, single stream pilots may be used for channel estimation purposes and for detecting frequency drift for estimating MIMO channel. When using single stream pilots, data subcarriers may be multiplied a matrix P before being transmitted while pilot subcarriers may be multiplied by a matrix R whose values may be different than the P matrix. This may allow for tracking phase offset and frequency offset during MIMO channel estimation at the receiver.

After multiplication by a matrix and transformation to a time domain signal, the resulting PAPR may be different when P matrix values are different than R matrix values. As such, having different P and R values results in different LTF sequences 514. Accordingly, according to various embodiments, the LTF may be chosen by identifying a sequence that minimizes the maximal PAPR over all possible P and R matrix values:

$$LTF = {min}_{S} + \{ {max}_{P , R} [ PAPR ( S , P , R ) ] \}$$

where S represents the possible sequences for all chosen tone values. As with the embodiment described above with reference to Table 3, data and pilot symbol values may be chosen from +1 or −1. As such, according to the fifth allocation of FIG. 6 where sub-carriers chosen for the pilot signals are at indices of −7, and +7 of the spectral line −13:13, where there are up to four streams to transmit, the LTF sequences 512 shown below in Table 4 have been determined to have low PAPR values for all possible P and R matrix values.

TABLE 4

| LTF_{-13:13} | PAPR |
|---|---|
| {1, 1, −1, 1, 1, −1, 1, 1, −1, −1, −1, −1, −1, 0, −1, 1, −1, 1, −1, −1, −1, 1, 1, −1, −1, −1, 1} | 2.8580 dB |
| {1, 1, 1, 1, 1, 1, 1, −1, 1, 1, −1, −1, −1, 0, 1, 1, −1, 1, 1, −1, −1, −1, 1, −1, 1, 1, −1} | 3.0931 dB |
| {1, 1, 1, −1, −1, −1, 1, 1, 1, −1, 1, 1, 1, 0, 1, 1, 1, −1, 1, 1, −1, −1, 1, −1, −1, 1, −1} | 3.0984 dB |
| {1, 1, −1, 1, −1, −1, 1, 1, 1, −1, 1, −1, −1, 0, 1, −1, −1, −1, −1, 1, 1, −1, 1, 1, 1, 1, −1} | 3.1144 dB |
| {1, −1, 1, −1, −1, 1, 1, −1, 1, 1, −1, −1, −1, 0, 1, 1, −1, −1, −1, 1, 1, 1, 1, 1, 1, 1, 1} | 3.1528 dB |
| {1, 1, 1, 1, 1, −1, 1, 1, −1, −1, 1, −1, −1, 0, 1, −1, −1, −1, 1, 1, 1, −1, −1, 1, −1, 1, −1} | 3.1580 dB |
| {1, 1, 1, 1, 1, −1, 1, −1, −1, 1, 1, −1, −1, 0, 1, −1, −1, 1, 1, −1, −1, −1, −1, 1, −1, 1, −1} | 3.1742 dB |
| {1, 1, 1, −1, −1, −1, 1, −1, −1, 1, 1, −1, −1, 0, −1, −1, 1, −1, −1, −1, −1, 1, −1, 1, −1, 1, 1} | 3.1780 dB |
| {1, 1, 1, −1, −1, −1, 1, 1, 1, 1, −1, 1, −1, 0, −1, −1, −1, −1, 1, −1, 1, 1, −1, 1, 1, −1, 1} | 3.1912 dB |
| {1, −1, −1, −1, −1, 1, 1, −1, −1, −1, 1, 1, 1, 0, 1, −1, 1, −1, −1, 1, −1, −1, −1, 1, −1, −1, 1} | 3.2136 dB |

Accordingly, the LTF sequences 514 of Table 4 may correspond to LTF sequences with optimally low PAPR values for a 32-point FFT for the fifth allocation shown in FIG. 6 for use with single stream pilots. The LTF sequences 514 may correspond to training sequences with low PAPR values when using a four times oversampled IFFT.

As each sub-carrier allocation as shown in FIG. 6 has different subcarrier mappings, each allocation may have optimized STF and LTF sequences for reduced PAPR like those described above with reference to the fifth subcarrier allocation of FIG. 6.

According to another embodiment, STF and LTF sequences 512 and 514 with low PAPR values are identified for the seventh subcarrier allocation of FIG. 6. In the seventh sub-carrier allocation, there are 7 guard subcarriers 604, 1 DC subcarrier 606, 2 pilot subcarriers 610 at {−7,+7}, and 22 data subcarriers 612. The guard subcarriers may correspond to the first four subcarriers and the last three subcarriers. As described above, values of zero are chosen for the guard subcarriers and the DC subcarrier. The DC tone may be located at index 0 in the spectral line. Table 5 below shows STF sequences 512 optimized for low PAPR for the seventh allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-12:12}.

TABLE 5

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j} | 2.2303 dB |
| \sqrt{1/2} {−1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j} | 2.2303 dB |
| \sqrt{1/2} {1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j} | 2.2303 dB |
| \sqrt{1/2} {−1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j} | 2.2303 dB |
| \sqrt{1/2} {1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j} | 3.3095 dB |
| \sqrt{1/2} {1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j} | 3.3095 dB |
| \sqrt{1/2}{−1 − j, 0, 0, 0, 1 + j, 0, 0, 0, 1 + j, 0, 0, 0, 0, 0, 0, 0, 1 + j, 0, 0, 0, −1 − j, 0, 0, 0, −1 − j} | 3.3095 dB |
| \sqrt{1/2} {−1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j} | 3.3095 dB |
| \sqrt{1/2} {1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j} | 4.2597 dB |
| \sqrt{1/2} {1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j} | 4.2597 dB |

Accordingly, the STF sequences 512 of Table 5 may correspond to STF sequences with optimally low PAPR values for a 32-point FFT for the seventh allocation shown in FIG. 6. The STF sequences 512 may correspond to training sequences with low PAPR values when using a four times oversampled IFFT.

In another embodiment, STF sequences 512 for the seventh allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 6 below shows STF sequences 512 optimized for low PAPR for the seventh allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-12:12}.

TABLE 6

| M−12:12 | PAPR |
|---|---|
| \sqrt{1/2} {1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − j, 0, | 2.0589 dB |
| 1 + j, 0, −1 − j} | |
| \sqrt{1/2} {1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j} | |
| \sqrt{1/2} {−1 − j, 0, 1 + j, 0, −1 − j, 0, −1 − j, 0, 1 + j, 0, −1 − j, 0, 0, 0, −1 − j, 0, −1 − j, 0, −1 − j, 0, | 2.0589 dB |
| 1 + j, 0, 1 + j, 0, 1 + j} | |
| \sqrt{1/2}{−1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, | 2.0589 dB |
| −1 − j, 0, 1 + j} | |
| \sqrt{1/2} {1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, | 2.2394 dB |
| −1 − j, 0, 1 + j} | |
| \sqrt{1/2}{1 + j, 0, −1 − j, 0, 1 + j, 0, −1 − j, 0, −1 − j, 0, 1 + j, 0, 0, 0, −1 − j, 0, −1 − j, 0, 1 + j, 0, | 2.2394 dB |
| 1 + j, 0, 1 + j, 0, 1 + j} | |
| \sqrt{1/2} {−1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, | 2.2394 dB |
| −1 − j, 0, −1 − j} | |
| \sqrt{1/2}{−1 − j, 0, −1 − j, 0, −1 − j, 0, −1 − j, 0, 1 + j, 0, 1 + j, 0, 0, 0, −1 − j, 0, 1 + j, 0, 1 + j, 0, | 2.2394 dB |
| −1 − j, 0, 1 + j, 0, −1 − j} | |
| \sqrt{1/2}{1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, | 2.2974 dB |
| −1 − j, 0, 1 + j} | |
| \sqrt{1/2} {−1 − j, 0, −1 − j, 0, −1 − j, 0, −1 − j, 0, −1 − j, 0, 1 + j, 0, 0, 0, 1 + j, 0, −1 − j, 0, −1 − j, 0, | 2.2974 dB |
| 1 + j, 0, 1 + j, 0, −1 − j} | |

Accordingly, the STF sequences 512 of Table 6 may correspond to STF sequences with optimally low PAPR values for a 32-point FFT for the seventh allocation shown in FIG. 6 for use with an extended mode range. The STF sequences 512 may correspond to training sequences with low PAPR values when using a four times oversampled IFFT.

In another embodiment, LTF sequences 514 for the seventh allocation of FIG. 6 may be determined Table 7 below shows LTF sequences optimized for low PAPR for the seventh allocation shown in FIG. 6 where the values for all the data and pilot subcarriers are chosen from either +1 or −1 in the spectral line of LTF_{-12:12}.

TABLE 7

| LTF_{-12:12} | PAPR |
|---|---|
| {1, 1, −1, −1, −1, −1, 1, 1, −1, 1, 1, −1, 0, 1, 1, 1, −1, 1, 1, −1, 1, −1, 1, −1, 1} | 1.8712 dB |
| {1, −1, −1, −1, 1, −1, −1, 1, 1, 1, 1, 1, 0, 1, −1, −1, 1, 1, 1, 1, −1, 1, −1, 1, 1} | 2.1749 dB |
| {1, 1, 1, 1, 1, 1, −1, −1, −1, 1, 1, 1, 0, −1, 1, 1, −1, 1, 1, −1, −1, 1, −1, 1, −1} | 2.1821 dB |
| {1, 1, 1, 1, −1, −1, −1, −1, −1, 1, −1, −1, 0, 1, −1, −1, −1, 1, −1, 1, −1, −1, 1, −1, 1} | 2.1847 dB |
| {1, −1, 1, −1, −1, −1, 1, 1, 1, −1, 1, 1, 0, 1, −1, −1, −1, 1, −1, −1, 1, −1, −1, −1, −1} | 2.2697 dB |
| {1, 1, −1, −1, −1, −1, −1, −1, −1, 1, 1, −1, 0, −1, −1, 1, 1, −1, 1, −1, 1, −1, 1, 1, −1} | 2.2899 dB |
| {1, 1, 1, 1, 1, −1, 1, 1, 1, 1, −1, −1, 0, −1, 1, −1, 1, −1, 1, 1, −1, −1, 1, 1, −1} | 2.3227 dB |
| {1, 1, 1, 1, 1, 1, −1, 1, −1, −1, −1, 1, 0, 1, 1, −1, 1, −1, −1, 1, 1, 1, −1, −1, 1} | 2.3775 dB |
| {1, 1, −1, −1, −1, 1, 1, 1, 1, 1, 1, −1, 0, −1, 1, −1, −1, −1, 1, −1, −1, 1, −1, −1, 1} | 2.3892 dB |
| {1, −1, −1, −1, 1, −1, −1, −1, 1, −1, 1, −1, 0, 1, −1, 1, −1, −1, 1, 1, 1, 1, 1, −1, −1} | 2.4027 dB |

Accordingly, the LTF sequences 514 of Table 7 may correspond to LTF sequences with optimally low PAPR values for a 32-point FFT for the seventh allocation shown in FIG. 6. The LTF sequences 514 may correspond to training sequences with low PAPR values when using a four times oversampled IFFT.

In another embodiment, LTF sequences 514 for the seventh allocation of FIG. 6 may be determined for use with single stream pilots. Table 8 below shows LTF sequences optimized for low PAPR for the seventh allocation shown in FIG. where the values for all the data and pilot subcarriers are chosen from either +1 or −1 in the spectral line of LTF_{-12:12}, the pilot subcarriers have indices of +7 and −7 for the spectral line, and the LTF sequences are chose to minimize the maximal PAPR for all possible P and R values for up to 4 streams to transmit.

TABLE 8

| LTF_{-12:12} | PAPR |
|---|---|
| {1, 1, 1, 1, 1, 1, −1, 1, 1, 1, −1, −1, 0, −1, 1, 1, −1, 1, 1, −1, −1, 1, −1, 1, −1} | 2.7429 dB |
| {1, 1, 1, −1, −1, 1, 1, 1, −1, 1, −1, 1, 0, 1, 1, 1, 1, 1, −1, −1, 1, −1, −1, 1, −1} | 2.8978 dB |
| {1, −1, 1, 1, −1, 1, 1, −1, 1, 1, 1, 1, 0, 1, −1, 1, −1, −1, −1, 1, 1, 1, −1, −1, −1} | 2.9349 dB |
| {1, −1, −1, 1, −1, 1, 1, −1, −1, −1, −1, 1, 0, 1, 1, 1, 1, −1, 1, 1, 1, −1, 1, 1, 1} | 2.9448 dB |
| {1, 1, −1, −1, −1, 1, −1, 1, 1, −1, −1, −1, 0, −1, 1, −1, −1, 1, 1, 1, 1, −1, 1, 1, −1} | 2.9661 dB |
| {1, 1, −1, 1, −1, 1, −1, 1, 1, −1, −1, 1, 0, 1, 1, −1, −1, 1, 1, −1, 1, 1, 1, 1, −1} | 3.0413 dB |
| {1, −1, 1, 1, −1, 1, 1, −1, −1, 1, −1, 1, 0, 1, 1, 1, 1, −1, −1, 1, 1, 1, −1, −1, −1} | 3.0803 dB |
| {1, 1, 1, −1, −1, 1, 1, −1, −1, −1, −1, −1, 0, −1, 1, −1, 1, −1, −1, −1, 1, −1, −1, 1, −1} | 3.1139 dB |
| {1, −1, −1, 1, −1, 1, −1, 1, −1, −1, −1, −1, 0, 1, −1, 1, −1, −1, 1, 1, −1, −1, 1, 1, 1} | 3.1302 dB |
| {1, 1, 1, 1, 1, 1, 1, −1, −1, 1, 1, −1, 0, −1, −1, 1, −1, 1, −1, 1, −1, 1, 1, −1, −1} | 3.1405 dB |

Accordingly, the LTF sequences 514 of Table 8 may correspond to LTF sequences with optimally low PAPR values for a 32-point FFT for use with single stream pilots for the seventh allocation shown in FIG. 6. The LTF sequences 514 may correspond to training sequences with low PAPR values when using a four times oversampled IFFT.

According to another embodiment, STF and LTF sequences 512 and 514 with low PAPR values are identified for the third subcarrier allocation of FIG. 6. In the third sub-carrier allocation, there are 3 guard subcarriers 604, 1 DC subcarrier 606, 2 pilot subcarriers 610 at {−7,+7}, and 26 data subcarriers 612. The guard subcarriers may correspond to the first two subcarriers and the last subcarrier. As described above, values of zero are chosen for the guard subcarriers and the DC subcarrier. The DC tone may be located at index 0 in the spectral line. Table 9 below shows STF sequences 512 optimized for low PAPR for the third allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-14:14}.

TABLE 9

| S_{-14:14} | PAPR |
|---|---|
| \sqrt{1/2} {0, 0, 1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j, 0, 0} | 2.2303 dB |
| \sqrt{1/2} {0, 0, −1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j, 0, 0} | 2.2303 dB |
| \sqrt{1/2} {0, 0, 1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j, 0, 0} | 2.2303 dB |
| \sqrt{1/2} {0, 0, −1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j, 0, 0} | 2.2303 dB |
| \sqrt{1/2} {0, 0, 1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j, 0, 0} | 3.3095 dB |
| \sqrt{1/2} {0, 0, 1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j, 0, 0} | 3.3095 dB |
| \sqrt{1/2} {0, 0, −1 − j, 0, 0, 0, 1 + j, 0, 0, 0, 1 + j0, 0, 0, 0, 0, 0, 0, 1 + j, 0, 0, 0, −1 − j, 0, 0, 0, −1 − j, 0, 0} | 3.3095 dB |
| \sqrt{1/2}{0, 0, −1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j, 0, 0} | 3.3095 dB |
| \sqrt{1/2}{0, 0, 1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j, 0, 0} | 4.2597 dB |
| \sqrt{1/2} {0, 0, 1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j, 0, 0} | 4.2597 dB |

Accordingly, the STF sequences 512 of Table 9 may correspond to STF sequences with optimally low PAPR values for a 32-point FFT for the third allocation shown in FIG. 6. The STF sequences 512 may correspond to training sequences with low PAPR values when using a four times oversampled IFFT.

In another embodiment, STF sequences 512 for the third allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 10 below shows STF sequences 512 optimized for low PAPR for the third allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-14:14}.

TABLE 10

| M−14:14 | PAPR |
|---|---|
| \sqrt{1/2} {0, 0, 1 + j, 0, 1 + j, 0, 1 + j, 0, −1 − j, 0, −1 − j, 0, −1 − j, 0, 0, 0, −1 − j, 0, 1 + j, 0, −1 − j, 0, | 2.0589 dB |
| −1 − j, 0, 1 + j, 0, −1 − j, 0, 0} | |
| \sqrt{1/2} {0, 0, 1 + j, 0, −1 − j, 0, 1 + j, 0, 1 + j, 0, −1 − j, 0, 1 + j, 0, 0, 0, 1 + j, 0, 1 + j, 0, 1 + j, 0, | 2.0589 dB |
| −1 − j, 0, −1 − j, 0, −1 − j, 0, 0} | |
| \sqrt{1/2}{0, 0, −1 − j, 0, 1 + j, 0, −1 − j, 0, −1 − j, 0, 1 + j, 0, −1 − j, 0, 0, 0, −1 − j, 0, −1 − j, 0, −1 − j, 0, | 2.0589 dB |
| 1 + j, 0, 1 + j, 0, 1 + j, 0, 0} | |
| \sqrt{1/2} {0, 0, −1 − j, 0, −1 − j, 0, −1 − j, 0, 1 + j, 0, 1 + j, 0, 1 + j, 0, 0, 0, 1 + j, 0, −1 − j, 0, 1 + j, 0, | 2.0589 dB |
| 1 + j, 0, −1 − j, 0, 1 + j, 0, 0} | |
| \sqrt{1/2}{0, 0, 1 + j, 0, 1 + j, 0, 1 + j, 0, 1 + j, 0, −1 − j, 0, −1 − j, 0, 0, 0, 1 + j, 0, −1 − j, 0, −1 − j, 0, | 2.2394 dB |
| 1 + j, 0, −1 − j, 0, 1 + j, 0, 0} | |
| \sqrt{1/2}{0, 0, 1 + j, 0, −1 − j, 0, 1 + j, 0, −1 − j, 0, −1 − j, 0, 1 + j, 0, 0, 0, −1 − j, 0, −1 − j, 0, 1 + j, 0, | 2.2394 dB |
| 1 + j, 0, 1 + j, 0, 1 + j, 0, 0} | |
| \sqrt{1/2} {0, 0, −1 − j, 0, 1 + j, 0, −1 − j, 0, 1 + j, 0, 1 + j, 0, −1 − j, 0, 0, 0, 1 + j, 0, 1 + j, 0, −1 − j, 0, | 2.2394 dB |
| −1 − j, 0, −1 − j, 0, −1 − j, 0, 0} | |
| \sqrt{1/2} {0, 0, −1 − j, 0, −1 − j, 0, −1 − j, 0, −1 − j, 0, 1 + j, 0, 1 + j, 0, 0, 0, −1 − j, 0, 1 + j, 0, 1 + j, 0, | 2.2394 dB |
| −1 − j, 0, 1 + j, 0, −1 − j, 0, 0} | |
| \sqrt{1/2} {0, 0, 1 + j, 0, 1 + j, 0, 1 + j, 0, 1 + j, 0, 1 + j, 0, −1 − j, 0, 0, 0, −1 − j, 0, 1 + j, 0, 1 + j, 0, | 2.2974 dB |
| −1 − j, 0, −1 − j, 0, 1 + j, 0, 0} | |
| \sqrt{1/2}{0, 0, −1 − j, 0, −1 − j, 0, −1 − j, 0, −1 − j, 0, −1 − j, 0, 1 + j, 0, 0, 0, 1 + j, 0, −1 − j, 0, −1 − j, 0, | 2.2974 dB |
| 1 + j, 0, 1 + j, 0, −1 − j, 0, 0} | |

Accordingly, the STF sequences 512 of Table 10 may correspond to STF sequences with optimally low PAPR values for a 32-point FFT for the third allocation shown in FIG. 6 for use with an extended range mode. The STF sequences 512 may correspond to training sequences with low PAPR values when using a four times oversampled IFFT.

In another embodiment, LTF sequences 514 for the third allocation of FIG. 6 may be determined Table 11 below shows LTF sequences optimized for low PAPR where the values for all the data and pilot subcarriers are chosen from either +1 or −1 in the spectral line of LTF_{-14:14}.

TABLE 11

| LTF_{-14:14} | PAPR |
|---|---|
| {1, −1, 1, 1, −1, −1, 1, −1, −1, 1, −1, 1, −1, 1, 0, −1, −1, −1, −1, −1, −1, 1, 1, 1, −1, −1, 1, 1, 1} | 1.8230 dB |
| {1, 1, 1, 1, 1, 1, −1, −1, 1, 1, 1, −1, −1, −1, 0, 1, −1, 1, 1, −1, 1, 1, −1, −1, 1, −1, 1, −1, 1} | 1.8884 dB |
| {1, −1, 1, −1, 1, −1, 1, 1, −1, −1, −1, 1, 1, −1, 0, −1, −1, 1, 1, −1, 1, 1, −1, −1, −1, −1, −1, −1, −1} | 2.2242 dB |
| {1, 1, 1, 1, −1, −1, −1, 1, 1, 1, −1, 1, 1, 1, 0, −1, 1, −1, −1, −1, 1, −1, −1, 1, −1, −1, 1, −1, 1} | 2.2377 dB |
| {1, 1, 1, −1, −1, 1, 1, 1, −1, −1, −1, −1, −1, −1, 0, 1, −1, 1, 1, −1, −1, 1, −1, −1, 1, −1, 1, −1, 1} | 2.2753 dB |
| {1, 1, 1, 1, 1, 1, 1, 1, −1, −1, −1, 1, −1, 1, 0, 1, −1, −1, 1, −1, 1, 1, −1, 1, −1, −1, 1, 1, −1} | 2.2825 dB |
| {1, 1, 1, −1, −1, −1, −1, −1, −1, −1, 1, −1, 1, −1, 0, 1, −1, 1, −1, −1, 1, 1, −1, 1, 1, −1, −1, 1, 1} | 2.3065 dB |
| {1, −1, −1, 1, −1, 1, −1, −1, 1, −1, −1, −1, 1, −1, 0, −1, −1, −1, 1, −1, −1, −1, 1, 1, 1, 1, 1, −1, −1} | 2.3124 dB |
| {1, −1, 1, −1, 1, −1, 1, 1, −1, 1, 1, 1, 1, 1, 0, −1, −1, 1, 1, −1, −1, 1, −1, −1, −1, −1, 1, 1, −1} | 2.3161 dB |
| {1, 1, −1, −1, −1, −1, 1, −1, −1, −1, −1, 1, 1, 1, 0, 1, 1, −1, −1, 1, 1, −1, 1, 1, 1, −1, 1, −1, 1} | 2.3407 dB |

Accordingly, the LTF sequences 514 of Table 11 may correspond to LTF sequences with optimally low PAPR values for a 32-point FFT for the third allocation shown in FIG. 6. The LTF sequences 514 may correspond to training sequences with low PAPR values when using a four times oversampled IFFT.

In another embodiment, LTF sequences 514 for the third allocation of FIG. 6 may be determined for use with single stream pilots. Table 12 below shows LTF sequences optimized for low PAPR where the values for all the data and pilot subcarriers are chosen from either +1 or −1 in the spectral line of LTF_{-14:14}, the pilot subcarriers have indices of −7 and +7 for the spectral line, and the LTF sequences are chose to minimize the maximal PAPR for all possible P and R values for up to 4 streams to transmit.

TABLE 12

| LTF_{-14:14} | PAPR |
|---|---|
| {1, 1, −1, 1, −1, 1, −1, 1, 1, −1, −1, 1, 1, −1, 0, −1, −1, 1, 1, −1, −1, 1, 1, 1, 1, 1, 1, 1, −1} | 2.8723 dB |
| {1, 1, 1, 1, 1, 1, 1, 1, −1, −1, −1, 1, 1, −1, 0, 1, 1, −1, −1, 1, −1, −1, 1, −1, 1, −1, 1, −1, 1} | 3.0514 dB |
| {1, 1, 1, 1, 1, −1, −1, 1, 1, 1, −1, −1, 1, −1, 0, −1, −1, −1, 1, 1, −1, 1, 1, −1, −1, 1, −1, 1, −1} | 3.0559 dB |
| {1, 1, −1, 1, 1, −1, −1, 1, −1, −1, 1, −1, 1, −1, 0, −1, −1, −1, −1, −1, 1, 1, 1, −1, −1, 1, 1, 1, −1} | 3.0929 dB |
| {1, 1, −1, −1, 1, 1, 1, 1, −1, 1, 1, −1, 1, 1, 0, −1, −1, −1, −1, −1, 1, 1, −1, 1, −1, 1, −1, 1, −1} | 3.0989 dB |
| {1, −1, −1, 1, 1, 1, 1, 1, 1, 1, 1, −1, 1, −1, 0, 1, 1, −1, 1, −1, −1, 1, −1, 1, −1, 1, 1, −1, −1} | 3.1115 dB |
| {1, 1, −1, 1, 1, −1, 1, 1, −1, −1, −1, −1, −1, −1, 0, −1, 1, −1, 1, −1, 1, 1, −1, −1, −1, 1, 1, 1, −1} | 3.1383 dB |
| {1, 1, 1, 1, 1, 1, 1, 1, −1, −1, 1, 1, −1, −1, 0, 1, −1, 1, 1, 1, −1, −1, −1, −1, 1, 1, −1, 1, −1} | 3.1419 dB |
| {1, 1, 1, 1, −1, −1, −1, 1, 1, −1, −1, −1, 1, −1, 0, −1, −1, −1, 1, −1, −1, 1, 1, −1, 1, 1, −1, 1, −1} | 3.1539 dB |
| {1, 1, 1, −1, 1, −1, 1, 1, −1, 1, 1, 1, −1, −1, 0, 1, −1, −1, 1, −1, −1, −1, 1, 1, 1, 1, 1, −1, 1} | 3.1663 dB |

Accordingly, the LTF sequences 514 of Table 12 may correspond to LTF sequences with optimally low PAPR values for a 32-point FFT for use with single stream pilots for the third allocation shown in FIG. 6. The LTF sequences 514 may correspond to training sequences with low PAPR values when using a four times oversampled IFFT.

According to another embodiment, STF and LTF sequences 512 and 514 with low PAPR values are identified for the fourteenth subcarrier allocation of FIG. 6. In the fourteenth sub-carrier allocation, there are 5 guard subcarriers 604, 1 DC subcarrier 606, 2 pilot subcarriers 610 at {−9,+5}, and 24 data subcarriers 612. The guard subcarriers may correspond to the first three subcarriers and the last two subcarriers. As described above, values of zero are chosen for the guard subcarriers and the DC subcarrier. The DC tone may be located at index 0 in the spectral line. Table 13 below shows STF sequences 512 optimized for low PAPR for the fourteenth allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-13:13}.

TABLE 13

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j, 0} | 2.2303 dB |
| \sqrt{1/2} {0, −1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j, 0} | 2.2303 dB |
| \sqrt{1/2} {0, 1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j, 0} | 2.2303 dB |
| \sqrt{1/2} {0, −1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j, 0} | 2.2303 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j, 0} | 3.3095 dB |
| \sqrt{1/2} {0, 1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j, 0} | 3.3095 dB |
| \sqrt{1/2} {0, −1 − j, 0, 0, 0, 1 + j, 0, 0, 0, 1 + j0, 0, 0, 0, 0, 0, 0, 1 + j, 0, 0, 0, −1 − j, 0, 0, 0, −1 − j, 0} | 3.3095 dB |
| \sqrt{1/2} {0, −1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j, 0} | 3.3095 dB |
| \sqrt{1/2} {0, 1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j, 0} | 4.2597 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j, 0} | 4.2597 dB |

Accordingly, the STF sequences 512 of Table 13 may correspond to STF sequences with optimally low PAPR values for a 32-point FFT for the fourteenth allocation shown in FIG. 6. The STF sequences 512 may correspond to training sequences with low PAPR values when using a four times oversampled IFFT.

In another embodiment, STF sequences 512 for the fourteenth allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 14 below shows STF sequences 512 optimized for low PAPR for the fourteenth allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-13:13}.

TABLE 14

| M−13:13 | PAPR |
|---|---|
| \sqrt{1/2} {0, 1 + j, 0, 1 + j, 0, 1 + j, 0, −1 − j, 0, −1 − j, 0, −1 − j, 0, 0, 0, −1 − j, 0, 1 + j, 0, −1 − j, 0, | 2.0589 dB |
| −1 − j, 0, 1 + j, 0, −1 − j, 0} | |
| \sqrt{1/2} {0, 1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j, 0} | |
| \sqrt{1/2} {0, −1 − j, 0, 1 + j, 0, −1 − j, 0, −1 − j, 0, 1 + j, 0, −1 − j, 0, 0, 0, −1 − j, 0, −1 − j, 0, −1 − j, 0, | 2.0589 dB |
| 1 + j, 0, 1 + j, 0, 1 + j, 0} | |
| \sqrt{1/2} {0, −1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, | 2.0589 dB |
| −1 − j, 0, 1 + j, 0} | |
| \sqrt{1/2} {0, 1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, | 2.2394 dB |
| −1 − j, 0, 1 + j, 0} | |
| \sqrt{1/2} {0, 1 + j, 0, −1 − j, 0, 1 + j, 0, −1 − j, 0, −1 − j, 0, 1 + j, 0, 0, 0, −1 − j, 0, −1 − j, 0, 1 + j, 0, | 2.2394 dB |
| 1 + j, 0, 1 + j, 0, 1 + j, 0} | |
| \sqrt{1/2} {0, −1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, | 2.2394 dB |
| −1 − j, 0, −1 − j, 0} | |
| \sqrt{1/2} {0, −1 − j, 0, −1 − j, 0, −1 − j, 0, −1 − j, 0, 1 + j, 0, 1 + j, 0, 0, 0, −1 − j, 0, 1 + j, 0, 1 + j, 0, | 2.2394 dB |
| −1 − j, 0, 1 + j, 0, −1 − j, 0} | |
| \sqrt{1/2} {0, 1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, | 2.2974 dB |
| −1 − j, 0, 1 + j, 0} | |
| \sqrt{1/2} {0, −1 − j, 0, −1 − j, 0, −1 − j, 0, −1 − j, 0, −1 − j, 0, 1 + j, 0, 0, 0, 1 + j, 0, −1 − j, 0, −1 − j, 0, | 2.2974 dB |
| 1 + j, 0, 1 + j, 0, −1 − j, 0} | |

Accordingly, the STF sequences 512 of Table 14 may correspond to STF sequences with optimally low PAPR values for a 32-point FFT for the fourteenth allocation shown in FIG. 6. The STF sequences 512 may correspond to training sequences with low PAPR values when using a four times oversampled IFFT.

In another embodiment, LTF sequences 514 for the fourteenth allocation of FIG. 6 may be determined Table 15 below shows LTF sequences optimized for low PAPR where the values for all the data and pilot subcarriers are chosen from either +1 or −1 in the spectral line of LTF_{-13:13}.

TABLE 15

| LTF_{-13:13} | PAPR |
|---|---|
| {1, −1, 1, 1, −1, 1, 1, −1, 1, 1, 1, −1, 1, 0, −1, −1, −1, 1, −1, −1, −1, 1, 1, 1, −1, −1, −1} | 1.8365 dB |
| {1, −1, 1, −1, 1, −1, −1, 1, −1, −1, 1, 1, −1, 0, −1, −1, 1, 1, −1, −1, −1, 1, 1, 1, 1, 1, 1} | 1.9942 dB |
| {1, −1, 1, −1, 1, −1, 1, 1, −1, −1, −1, 1, 1, 0, 1, −1, −1, 1, −1, −1, 1, 1, 1, 1, 1, 1, 1} | 2.0381 dB |
| {1, −1, 1, −1, 1, 1, 1, 1, 1, 1, 1, 1, −1, 0, −1, −1, 1, −1, 1, 1, −1, −1, 1, 1, −1, −1, 1} | 2.2113 dB |
| {1, −1, 1, −1, 1, −1, −1, 1, 1, 1, −1, −1, 1, 0, 1, 1, −1, −1, 1, −1, −1, 1, 1, 1, 1, 1, 1} | 2.3083 dB |
| {1, 1, 1, −1, 1, −1, −1, −1, 1, 1, 1, 1, −1, 0, 1, 1, −1, 1, −1, −1, 1, −1, −1, −1, −1, 1, −1} | 2.3087 dB |
| {1, 1, 1, 1, 1, 1, 1, −1, −1, 1, −1, 1, −1, 0, −1, 1, 1, 1, −1, −1, −1, 1, 1, −1, 1, 1, −1} | 2.3140 dB |
| {1, 1, 1, 1, 1, −1, −1, −1, −1, −1, 1, −1, −1, 0, 1, −1, −1, −1, 1, −1, 1, −1, −1, 1, −1, 1, −1} | 2.3579 dB |
| {1, −1, −1, 1, 1, −1, −1, 1, −1, −1, 1, −1, 1, 0, 1, 1, 1, 1, 1, 1, 1, −1, −1, −1, 1, 1, 1} | 2.3622 dB |
| {1, 1, −1, −1, −1, −1, 1, 1, 1, 1, −1, 1, −1, 0, −1, 1, −1, −1, −1, 1, −1, −1, −1, −1, 1, −1, −1} | 2.3983 dB |

Accordingly, the LTF sequences 514 of Table 15 may correspond to LTF sequences with optimally low PAPR values for a 32-point FFT for the fourteenth allocation shown in FIG. 6. The LTF sequences 514 may correspond to training sequences with low PAPR values when using a four times oversampled IFFT.

In another embodiment, LTF sequences 514 for the fourteenth allocation of FIG. 6 may be determined for use with single stream pilots. Table 16 below shows LTF sequences optimized for low PAPR where the values for all the data and pilot subcarriers are chosen from either +1 or −1 in the spectral line of LTF_{-13:13}, the pilot subcarriers have indices of −9 and +5 for the spectral line, and the LTF sequences are chose to minimize the maximal PAPR for all possible P and R values for up to 4 streams to transmit.

TABLE 16

| LTF_{-13:13} | PAPR |
|---|---|
| {1, 1, 1, 1, 1, 1, 1, 1, −1, −1, −1, −1, 1, 0, 1, 1, −1, −1, 1, 1, −1, −1, 1, 1, −1, 1, −1} | 2.9479 dB |
| {1, 1, −1, −1, 1, 1, 1, −1, −1, −1, −1, −1, −1, 0, −1, 1, 1, −1, 1, 1, −1, −1, 1, −1, 1, −1, 1} | 2.9549 dB |
| {1, 1, −1, 1, 1, 1, −1, 1, 1, −1, 1, −1, −1, 0, −1, −1, 1, −1, 1, 1, 1, −1, −1, −1, 1, 1, 1} | 2.9803 dB |
| {1, 1, 1, 1, 1, 1, −1, 1, −1, 1, −1, −1, 1, 0, −1, 1, 1, −1, −1, −1, −1, 1, 1, 1, −1, −1, 1} | 3.0624 dB |
| {1, 1, −1, 1, 1, 1, −1, 1, 1, −1, 1, 1, −1, 0, 1, 1, 1, −1, −1, 1, 1, 1, 1, −1, −1, −1, −1} | 3.1362 dB |
| {1, 1, 1, 1, 1, −1, −1, 1, 1, −1, −1, −1, 1, 0, −1, −1, 1, −1, 1, −1, 1, −1, 1, 1, −1, 1, −1} | 3.1481 dB |
| {1, 1, 1, 1, 1, 1, 1, 1, −1, −1, 1, −1, −1, 0, 1, −1, 1, 1, 1, −1, −1, −1, 1, 1, −1, 1, −1} | 3.1521 dB |
| {1, −1, 1, −1, 1, 1, −1, 1, −1, −1, −1, 1, 1, 0, 1, 1, −1, −1, 1, −1, −1, −1, −1, 1, 1, −1, −1} | 3.1734 dB |
| {1, 1, −1, −1, 1, 1, −1, −1, −1, −1, −1, 1, 1, 0, 1, −1, −1, −1, −1, −1, −1, 1, −1, 1, −1, −1, 1} | 3.2298 dB |
| {1, 1, 1, −1, 1, −1, −1, −1, 1, −1, −1, −1, 1, 0, −1, −1, −1, 1, 1, −1, −1, 1, −1, 1, 1, −1, 1} | 3.2362 dB |

Accordingly, the LTF sequences 514 of Table 16 may correspond to LTF sequences with optimally low PAPR values for a 32-point FFT for use with single stream pilots for the fourteenth allocation shown in FIG. 6. The LTF sequences 514 may correspond to training sequences with low PAPR values when using a four times oversampled IFFT.

According to another embodiment, STF and LTF sequences 512 and 514 with low PAPR values are identified for the sixteenth subcarrier allocation of FIG. 6. In the sixteenth sub-carrier allocation, there are 7 guard subcarriers 604, 1 DC subcarrier 606, 2 pilot subcarriers 610 at {−9,+5}, and 22 data subcarriers 612. The guard subcarriers may correspond to the first four subcarriers and the last three subcarriers. As described above, values of zero are chosen for the guard subcarriers and the DC subcarrier. The DC tone may be located at index 0 in the spectral line. Table 12 below shows STF sequences 512 optimized for low PAPR for the sixteenth allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-12:12}.

TABLE 17

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j} | 2.2303 dB |
| \sqrt{1/2} {−1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j} | 2.2303 dB |
| \sqrt{1/2} {1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j} | 2.2303 dB |
| \sqrt{1/2} {−1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j} | 2.2303 dB |
| \sqrt{1/2} {1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j} | 3.3095 dB |
| \sqrt{1/2} {1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j} | 3.3095 dB |
| \sqrt{1/2} {−1 − j, 0, 0, 0, 1 + j, 0, 0, 0, 1 + j0, 0, 0, 0, 0, 0, 0, 1 + j, 0, 0, 0, −1 − j, 0, 0, 0, −1 − j} | 3.3095 dB |
| \sqrt{1/2} {−1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j} | 3.3095 dB |
| \sqrt{1/2} {1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j} | 4.2597 dB |
| \sqrt{1/2} {1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j} | 4.2597 dB |

Accordingly, the STF sequences 512 of Table 13 may correspond to STF sequences with optimally low PAPR values for a 32-point FFT for the sixteenth allocation shown in FIG. 6. The STF sequences 512 may correspond to training sequences with low PAPR values when using a four times oversampled IFFT.

In another embodiment, STF sequences 512 for the sixteenth allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 14 below shows STF sequences 512 optimized for low PAPR for the sixteenth allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-12:12}.

TABLE 18

| M−12:12 | PAPR |
|---|---|
| \sqrt{1/2} {1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − j, 0, | 2.0589 dB |
| 1 + j, 0, −1 − j} | |
| \sqrt{1/2} {1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j} | |
| \sqrt{1/2} {−1 − j, 0, 1 + j, 0, −1 − j, 0, −1 − j, 0, 1 + j, 0, −1 − j, 0, 0, 0, −1 − j, 0, −1 − j, 0, −1 − j, 0, 1 + j, 0, | 2.0589 dB |
| 1 + j, 0, 1 + j} | |
| \sqrt{1/2} {−1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, | 2.0589 dB |
| −1 − j, 0, 1 + j} | |
| \sqrt{1/2} {1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, | 2.2394 dB |
| −1 − j, 0, 1 + j} | |
| \sqrt{1/2} {1 + j, 0, −1 − j, 0, 1 + j, 0, −1 − j, 0, −1 − j, 0, 1 + j, 0, 0, 0, −1 − j, 0, −1 − j, 0, 1 + j, 0, 1 + j, 0, | 2.2394 dB |
| 1 + j, 0, 1 + j} | |
| \sqrt{1/2} {−1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, | 2.2394 dB |
| −1 − j, 0, −1 − j} | |
| \sqrt{1/2} {−1 − j, 0, −1 − j, 0, −1 − j, 0, −1 − j, 0, 1 + j, 0, 1 + j, 0, 0, 0, −1 − j, 0, 1 + j, 0, 1 + j, 0, −1 − j, 0, | 2.2394 dB |
| 1 + j, 0, −1 − j} | |
| \sqrt{1/2} {1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, | 2.2974 dB |
| −1 − j, 0, 1 + j} | |
| \sqrt{1/2} {−1 − j, 0, −1 − j, 0, −1 − j, 0, −1 − j, 0, −1 − j, 0, 1 + j, 0, 0, 0, 1 + j, 0, −1 − j, 0, −1 − j, 0, 1 + j, 0, | 2.2974 dB |
| 1 + j, 0, −1 − j} | |

Accordingly, the STF sequences 512 of Table 14 may correspond to STF sequences with optimally low PAPR values for a 32-point FFT for the sixteenth allocation shown in FIG. 6. The STF sequences 512 may correspond to training sequences with low PAPR values when using a four times oversampled IFFT.

In another embodiment, LTF sequences 514 for the sixteenth allocation of FIG. 6 may be determined Table 15 below shows LTF sequences optimized for low PAPR where the values for all the data and pilot subcarriers are chosen from either +1 or −1 in the spectral line of LTF_{-12:12}.

TABLE 19

| LTF_{-12:12} | PAPR |
|---|---|
| {1, 1, −1, −1, −1, −1, 1, 1, −1, 1, 1, −1, 0, 1, 1, 1, −1, 1, 1, −1, 1, −1, 1, −1, 1} | 1.8712 dB |
| {1, −1, −1, −1, 1, −1, −1, 1, 1, 1, 1, 1, 0, 1, −1, −1, 1, 1, 1, 1, −1, 1, −1, 1, 1} | 2.1749 dB |
| {1, 1, 1, 1, 1, 1, −1, −1, −1, 1, 1, 1, 0, −1, 1, 1, −1, 1, 1, −1, −1, 1, −1, 1, −1} | 2.1821 dB |
| {1, 1, 1, 1, −1, −1, −1, −1, −1, 1, −1, −1, 0, 1, −1, −1, −1, 1, −1, 1, −1, −1, 1, −1, 1} | 2.1847 dB |
| {1, −1, 1, −1, −1, −1, 1, 1, 1, −1, 1, 1, 0, 1, −1, −1, −1, 1, −1, −1, 1, −1, −1, −1, −1} | 2.2697 dB |
| {1, 1, −1, −1, −1, −1, −1, −1, −1, 1, 1, −1, 0, −1, −1, 1, 1, −1, 1, −1, 1, −1, 1, 1, −1} | 2.2899 dB |
| {1, 1, 1, 1, 1, −1, 1, 1, 1, 1, −1, −1, 0, −1, 1, −1, 1, −1, 1, 1, −1, −1, 1, 1, −1} | 2.3227 dB |
| {1, 1, 1, 1, 1, 1, −1, 1, −1, −1, −1, 1, 0, 1, 1, −1, 1, −1, −1, 1, 1, 1, −1, −1, 1} | 2.3775 dB |
| {1, 1, −1, −1, −1, 1, 1, 1, 1, 1, 1, −1, 0, −1, 1, −1, −1, −1, 1, −1, −1, 1, −1, −1, 1} | 2.3892 dB |
| {1, −1, −1, −1, 1, −1, −1, −1, 1, −1, 1, −1, 0, 1, −1, 1, −1, −1, 1, 1, 1, 1, 1, −1, −1} | 2.4027 dB |

Accordingly, the LTF sequences 514 of Table 15 may correspond to LTF sequences with optimally low PAPR values for a 32-point FFT for the sixteenth allocation shown in FIG. 6. The LTF sequences 514 may correspond to training sequences with low PAPR values when using a four times oversampled IFFT.

In another embodiment, LTF sequences 514 for the sixteenth allocation of FIG. 6 may be determined for use with single stream pilots. Table 16 below shows LTF sequences optimized for low PAPR where the values for all the data and pilot subcarriers are chosen from either +1 or −1 in the spectral line of LTF_{-12:12}, the pilot subcarriers have indices of −9 and +5 for the spectral line, and the LTF sequences are chose to minimize the maximal PAPR for all possible P and R values for up to 4 streams to transmit.

TABLE 20

| LTF_{-12:12} | PAPR |
|---|---|
| {1, 1, −1, 1, −1, 1, −1, −1, −1, 1, −1, 1, 0, −1, 1, 1, 1, 1, 1, −1, −1, 1, 1, 1, 1} | 3.1471 dB |
| {1, −1, −1, 1, −1, −1, −1, 1, 1, −1, −1, 1, 0, 1, 1, −1, −1, −1, −1, −1, −1, 1, −1, 1, −1} | 3.2485 dB |
| {1, −1, −1, 1, 1, 1, 1, 1, 1, −1, −1, 1, 0, −1, −1, −1, −1, 1, 1, −1, −1, 1, −1, 1, −1} | 3.2718 dB |
| {1, 1, 1, 1, −1, 1, −1, 1, 1, 1, −1, 1, 0, −1, −1, 1, −1, −1, 1, −1, 1, 1, 1, 1, −1} | 3.2942 dB |
| {1, −1, 1, 1, 1, 1, 1, −1, 1, 1, 1, −1, 0, 1, −1, −1, −1, 1, −1, 1, 1, 1, 1, −1, −1} | 3.3128 dB |
| {1, 1, 1, 1, 1, 1, 1, −1, 1, −1, −1, −1, 0, 1, 1, 1, −1, −1, −1, 1, 1, −1, 1, 1, −1} | 3.3163 dB |
| {1, −1, 1, 1, 1, 1, −1, −1, −1, 1, 1, 1, 0, 1, 1, 1, −1, 1, 1, −1, −1, 1, −1, −1, −1} | 3.3171 dB |
| {1, 1, 1, 1, 1, −1, 1, −1, 1, −1, −1, 1, 0, 1, −1, −1, −1, 1, 1, −1, −1, 1, −1, −1, 1} | 3.3237 dB |
| {1, −1, 1, 1, 1, 1, −1, −1, 1, −1, 1, 1, 0, 1, 1, 1, −1, 1, −1, −1, −1, 1, 1, −1, −1} | 3.3342 dB |
| {1, 1, −1, 1, 1, −1, 1, 1, 1, −1, −1, 1, 0, 1, −1, 1, 1, 1, 1, −1, −1, −1, −1, −1, 1} | 3.3429 dB |

Accordingly, the LTF sequences 514 of Table 16 may correspond to LTF sequences with optimally low PAPR values for a 32-point FFT for use with single stream pilots for the sixteenth allocation shown in FIG. 6. The LTF sequences 514 may correspond to training sequences with low PAPR values when using a four times oversampled IFFT.

According to another embodiment, STF and LTF sequences 512 and 514 with low PAPR values are identified for the twentieth subcarrier allocation of FIG. 6. In the twentieth sub-carrier allocation, there are 5 guard subcarriers 604, 1 DC subcarrier 606, 4 pilot subcarriers 610 at {−3,+3,−10,+10}, and 22 data subcarriers 612. The guard subcarriers may correspond to the first three subcarriers and the last two subcarriers. As described above, values of zero are chosen for the guard subcarriers and the DC subcarrier. The DC tone may be located at index 0 in the spectral line. Table 21 below shows STF sequences 512 optimized for low PAPR for the twentieth allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-13:13}.

TABLE 21

| S_{-13:13} | PAPR |
|---|---|
| \sqrt{1/2} {0, 1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j, 0} | 2.2303 dB |
| \sqrt{1/2} {0, −1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j, 0} | 2.2303 dB |
| \sqrt{1/2} {0, 1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j, 0} | 2.2303 dB |
| \sqrt{1/2} {0, −1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j, 0} | 2.2303 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j, 0} | 3.3095 dB |
| \sqrt{1/2} {0, 1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j, 0} | 3.3095 dB |
| \sqrt{1/2} {0, −1 − j, 0, 0, 0, 1 + j, 0, 0, 0, 1 + j0, 0, 0, 0, 0, 0, 0, 1 + j, 0, 0, 0, −1 − j, 0, 0, 0, −1 − j, 0} | 3.3095 dB |
| \sqrt{1/2} {0, −1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j, 0} | 3.3095 dB |
| \sqrt{1/2} {0, 1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j, 0} | 4.2597 dB |
| \sqrt{1/2} {0, 1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j, 0} | 4.2597 dB |

Accordingly, the STF sequences 512 of Table 21 may correspond to STF sequences with optimally low PAPR values for a 32-point FFT for the twentieth allocation shown in FIG. 6. The STF sequences 512 may correspond to training sequences with low PAPR values when using a four times oversampled IFFT.

In another embodiment, STF sequences 512 for the twentieth allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 22 below shows STF sequences 512 optimized for low PAPR for the twentieth allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-13:13}.

TABLE 22

| M_{-13:13} | PAPR |
|---|---|
| \sqrt{1/2} {0, 1 + j, 0, 1 + j, 0, 1 + j, 0, −1 − j, 0, −1 − j, 0, −1 − j, 0, 0, 0, −1 − j, 0, 1 + j, 0, −1 − j, 0, | 2.0589 dB |
| −1 − j, 0, 1 + j, 0, −1 − j, 0} | |
| \sqrt{1/2} {0, 1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j, 0} | |
| \sqrt{1/2} {0, −1 − j, 0, 1 + j, 0, −1 − j, 0, −1 − j, 0, 1 + j, 0, −1 − j, 0, 0, 0, −1 − j, 0, −1 − j, 0, −1 − j, 0, | 2.0589 dB |
| 1 + j, 0, 1 + j, 0, 1 + j, 0} | |
| \sqrt{1/2} {0, −1 − j, 0, −1 − j, 0, −1 − j, 0, 1 + j, 0, 1 + j, 0, 1 + j, 0, 0, 0, 1 + j, 0, −1 − j, 0, 1 + j, 0, | 2.0589 dB |
| 1 + j, 0, −1 − j, 0, 1 + j, 0} | |
| \sqrt{1/2} {0, 1 + j, 0, 1 + j, 0, 1 + j, 0, 1 + j, 0, −1 − j, 0, −1 − j, 0, 0, 0, 1 + j, 0, −1 − j, 0, −1 − j, 0, | 2.2394 dB |
| 1 + j, 0, −1 − j, 0, 1 + j, 0} | |
| \sqrt{1/2} {0, 1 + j, 0, −1 − j, 0, 1 + j, 0, −1 − j, 0, −1 − j, 0, 1 + j, 0, 0, 0, −1 − j, 0, −1 − j, 0, 1 + j, 0, | 2.2394 dB |
| 1 + j, 0, 1 + j, 0, 1 + j, 0} | |
| \sqrt{1/2} {0, −1 − j, 0, 1 + j, 0, −1 − j, 0, 1 + j, 0, 1 + j, 0, −1 − j, 0, 0, 0, 1 + j, 0, 1 + j, 0, −1 − j, 0, | 2.2394 dB |
| −1 − j, 0, −1 − j, 0, −1 − j, 0} | |
| \sqrt{1/2} {0, −1 − j, 0, −1 − j, 0, −1 − j, 0, −1 − j, 0, 1 + j, 0, 1 + j, 0, 0, 0, −1 − j, 0, 1 + j, 0, 1 + j, 0, | 2.2394 dB |
| −1 − j, 0, 1 + j, 0, −1 − j, 0} | |
| \sqrt{1/2} {0, 1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, | 2.2974 dB |
| −1 − j, 0, 1 + j, 0} | |
| \sqrt{1/2} {0, −1 − j, 0, −1 − j, 0, −1 − j, 0, −1 − j, 0, −1 − j, 0, 1 + j, 0, 0, 0, 1 + j, 0, −1 − j, 0, −1 − j, 0, | 2.2974 dB |
| 1 + j, 0, 1 + j, 0, −1 − j, 0} | |

Accordingly, the STF sequences 512 of Table 22 may correspond to STF sequences with optimally low PAPR values for a 32-point FFT for the twentieth allocation shown in FIG. 6 for use with an extended range mode. The STF sequences 512 may correspond to training sequences with low PAPR values when using a four times oversampled IFFT.

In another embodiment, LTF sequences 514 for the twentieth allocation of FIG. 6 may be determined Table 23 below shows LTF sequences optimized for low PAPR where the values for all the data and pilot subcarriers are chosen from either +1 or −1 in the spectral line of LTF_{-13:13}.

TABLE 23

| LTF_{-13:13} | PAPR |
|---|---|
| {1, −1, 1, 1, −1, 1, 1, −1, 1, 1, 1, −1, 1, 0, −1, −1, −1, 1, −1, −1, −1, 1, 1, 1, −1, −1, −1} | 1.8365 dB |
| {1, −1, 1, −1, 1, −1, −1, 1, −1, −1, 1, 1, −1, 0, −1, −1, 1, 1, −1, −1, −1, 1, 1, 1, 1, 1, 1} | 1.9942 dB |
| {1, −1, 1, −1, 1, −1, 1, 1, −1, −1, −1, 1, 1, 0, 1, −1, −1, 1, −1, −1, 1, 1, 1, 1, 1, 1, 1} | 2.0381 dB |
| {1, −1, 1, −1, 1, 1, 1, 1, 1, 1, 1, 1, −1, 0, −1, −1, 1, −1, 1, 1, −1, −1, 1, 1, −1, −1, 1} | 2.2113 dB |
| {1, −1, 1, −1, 1, −1, −1, 1, 1, 1, −1, −1, 1, 0, 1, 1, −1, −1, 1, −1, −1, 1, 1, 1, 1, 1, 1} | 2.3083 dB |
| {1, 1, 1, −1, 1, −1, −1, −1, 1, 1, 1, 1, −1, 0, 1, 1, −1, 1, −1, −1, 1, −1, −1, −1, −1, 1, −1} | 2.3087 dB |
| {1, 1, 1, 1, 1, 1, 1, −1, −1, 1, −1, 1, −1, 0, −1, 1, 1, 1, −1, −1, −1, 1, 1, −1, 1, 1, −1} | 2.3140 dB |
| {1, 1, 1, 1, 1, −1, −1, −1, −1, −1, 1, −1, −1, 0, 1, −1, −1, −1, 1, −1, 1, −1, −1, 1, −1, 1, −1} | 2.3579 dB |
| {1, −1, −1, 1, 1, −1, −1, 1, −1, −1, 1, −1, 1, 0, 1, 1, 1, 1, 1, 1, 1, −1, −1, −1, 1, 1, 1} | 2.3622 dB |
| {1, 1, −1, −1, −1, −1, 1, 1, 1, 1, −1, 1, −1, 0, −1, 1, −1, −1, −1, 1, −1, −1, −1, −1, 1, −1, −1} | 2.3983 dB |

Accordingly, the LTF sequences 514 of Table 23 may correspond to LTF sequences with optimally low PAPR values for a 32-point FFT for the twentieth allocation shown in FIG. 6. The LTF sequences 514 may correspond to training sequences with low PAPR values when using a four times oversampled IFFT.

In another embodiment, LTF sequences 514 for the twentieth allocation of FIG. 6 may be determined for use with single stream pilots. Table 24 below shows LTF sequences optimized for low PAPR where the values for all the data and pilot subcarriers are chosen from either +1 or −1 in the spectral line of LTF_{-13:13}, the pilot subcarriers have indices of −10,−3 and +3,+10 for the spectral line, and the LTF sequences are chose to minimize the maximal PAPR for all possible P and R values for up to four streams to transmit.

TABLE 24

| LTF_{-13:13} | PAPR |
|---|---|
| {1, 1, 1, 1, −1, 1, 1, 1, −1, 1, −1, 1, −1, 0, 1, −1, −1, −1, 1, −1, −1, 1, 1, 1, 1, −1, −1} | 3.0990 dB |
| {1, 1, 1, 1, 1, −1, 1, 1, −1, 1, −1, 1, 1, 0, −1, −1, 1, 1, −1, −1, −1, 1, −1, 1, 1, 1, −1} | 3.1116 dB |
| {1, 1, 1, 1, 1, −1, −1, −1, 1, 1, −1, 1, −1, 0, 1, 1, −1, 1, −1, 1, 1, 1, −1, 1, 1, −1, −1} | 3.1187 dB |
| {1, 1, 1, 1, −1, −1, −1, 1, −1, 1, 1, 1, −1, 0, 1, −1, 1, 1, −1, −1, −1, −1, 1, −1, −1, −1, 1} | 3.1725 dB |
| {1, 1, −1, 1, −1, −1, −1, 1, 1, −1, 1, −1, 1, 0, 1, −1, −1, −1, 1, −1, −1, −1, −1, −1, −1, −1, 1} | 3.1895 dB |
| {1, 1, −1, 1, 1, 1, 1, −1, 1, −1, 1, 1, −1, 0, −1, −1, −1, 1, 1, 1, 1, −1, 1, 1, −1, −1, 1} | 3.2166 dB |
| {1, 1, 1, 1, 1, −1, −1, 1, 1, 1, −1, −1, 1, 0, 1, 1, −1, 1, 1, −1, −1, 1, −1, 1, −1, 1, −1} | 3.2489 dB |
| {1, 1, 1, 1, −1, −1, −1, −1, −1, 1, 1, −1, −1, 0, −1, 1, −1, −1, −1, 1, −1, 1, −1, 1, 1, −1, 1} | 3.2718 dB |
| {1, 1, −1, 1, −1, 1, 1, −1, 1, −1, −1, −1, 1, 0, −1, −1, 1, 1, −1, −1, 1, −1, −1, −1, −1, −1, 1} | 3.2771 dB |
| {1, 1, 1, 1, 1, 1, 1, 1, −1, −1, −1, −1, 1, 0, 1, −1, 1, −1, −1, −1, 1, 1, −1, −1, 1, 1, −1} | 3.2916 dB |

Accordingly, the LTF sequences 514 of Table 24 may correspond to LTF sequences with optimally low PAPR values for a 32-point FFT for use with single stream pilots for the twentieth allocation shown in FIG. 6. The LTF sequences 514 may correspond to training sequences with low PAPR values when using a four times oversampled IFFT.

According to another embodiment, STF and LTF sequences 512 and 514 with low PAPR values are identified for the twenty-second subcarrier allocation of FIG. 6. In the twenty-second sub-carrier allocation, there are 7 guard subcarriers 604, 1 DC subcarrier 606, 4 pilot subcarriers 610 at {−3,+3, −10, +10}, and 20 data subcarriers 612. The guard subcarriers may correspond to the first 4 subcarriers and the last 3 subcarriers. As described above, values of zero are chosen for the guard subcarriers and the DC subcarrier. The DC tone may be located at index 0 in the spectral line. Table 25 below shows STF sequences 512 optimized for low PAPR for the twenty-second allocation shown in FIG. 6 where the values for pilot and data subcarriers are chosen from either \sqrt{½}(1+j) or \sqrt{½}(−1−j) where the non-zero values correspond to subcarriers having indices that are multiples of four in the spectral line of S_{-12:12}.

TABLE 25

| S_{-12:12} | PAPR |
|---|---|
| \sqrt{1/2} {1 + j, 0, 0, 0, −1 − j, 0, 0, 0, 1 + j, 0, 0, 0, 0, 0, 0, 0, −1 − j, 0, 0, 0, −1 − j, 0, 0, 0, −1 − j} | 2.2303 dB |
| \sqrt{1/2} {−1 − j, 0, 0, 0, 1 + j, 0, 0, 0, −1 − j, 0, 0, 0, 0, 0, 0, 0, 1 + j, 0, 0, 0, 1 + j, 0, 0, 0, 1 + j} | 2.2303 dB |
| \sqrt{1/2} {1 + j, 0, 0, 0, 1 + j, 0, 0, 0, 1 + j, 0, 0, 0, 0, 0, 0, 0, −1 − j, 0, 0, 0, 1 + j, 0, 0, 0, −1 − j} | 2.2303 dB |
| \sqrt{1/2} {−1 − j, 0, 0, 0, −1 − j, 0, 0, 0, −1 − j, 0, 0, 0, 0, 0, 0, 0, 1 + j, 0, 0, 0, −1 − j, 0, 0, 0, 1 + j} | 2.2303 dB |
| \sqrt{1/2} {1 + j, 0, 0, 0, 1 + j, 0, 0, 0, −1 − j, 0, 0, 0, 0, 0, 0, 0, −1 − j, 0, 0, 0, −1 − j, 0, 0, 0, 1 + j} | 3.3095 dB |
| \sqrt{1/2} {1 + j, 0, 0, 0, −1 − j, 0, 0, 0, −1 − j, 0, 0, 0, 0, 0, 0, 0, −1 − j, 0, 0, 0, 1 + j, 0, 0, 0, 1 + j} | 3.3095 dB |
| \sqrt{1/2} {−1 − j, 0, 0, 0, 1 + j, 0, 0, 0, 1 + j, 0, 0, 0, 0, 0, 0, 0, 1 + j, 0, 0, 0, −1 − j, 0, 0, 0, −1 − j} | 3.3095 dB |
| \sqrt{1/2} {−1 − j, 0, 0, 0, −1 − j, 0, 0, 0, 1 + j, 0, 0, 0, 0, 0, 0, 0, 1 + j, 0, 0, 0, 1 + j, 0, 0, 0, −1 − j} | 3.3095 dB |
| \sqrt{1/2} {1 + j, 0, 0, 0, 1 + j, 0, 0, 0, 1 + j, 0, 0, 0, 0, 0, 0, 0, 1 + j, 0, 0, 0, −1 − j, 0, 0, 0, 1 + j} | 4.2597 dB |
| \sqrt{1/2} {1 + j, 0, 0, 0, 1 + j, 0, 0, 0, −1 − j, 0, 0, 0, 0, 0, 0, 0, −1 − j, 0, 0, 0, 1 + j, 0, 0, 0, −1 − j} | 4.2597 dB |

Accordingly, the STF sequences 512 of Table 25 may correspond to STF sequences with optimally low PAPR values for a 32-point FFT for the twenty-second allocation shown in FIG. 6. The STF sequences 512 may correspond to training sequences with low PAPR values when using a four times oversampled IFFT.

In another embodiment, STF sequences 512 for the twenty-second allocation of FIG. 6 may also be determined for use with an extended range mode. As described above, rather than selecting every fourth pilot or data subcarrier to be modulated with a non-zero value, for an extended range mode, every two pilot or data subcarriers may be modulated with a non-zero value. Table 26 below shows STF sequences 512 optimized for low PAPR for the twenty-second allocation shown in FIG. 6 where the values for pilot and data subcarriers are chosen from either \sqrt{½}(1+j) or \sqrt{½}(−1−j) and where the non-zero values correspond to subcarriers having indices that are multiples of two in the spectral line of M_{-12:12}.

TABLE 26

| M−12:12 | PAPR |
|---|---|
| \sqrt{1/2} {1 + j, 0, 1 + j, 0, 1 + j, 0, −1 − j, 0, −1 − j, 0, −1 − j, 0, 0, 0, −1 − j, 0, 1 + j, 0, −1 − j, 0, −1 − j, 0, | 2.0589 dB |
| 1 + j, 0, −1 − j} | |
| \sqrt{1/2} {1 + j, 0, −1 − j, 0, 1 + j, 0, 1 + j, 0, −1 − j, 0, 1 + j, 0, 0, 0, 1 + j, 0, 1 + j, 0, 1 + j, 0, −1 − j, 0, | 2.0589 dB |
| −1 − j, 0, −1 − j} | |
| \sqrt{1/2} {−1 − j, 0, 1 + j, 0, −1 − j, 0, −1 − j, 0, 1 + j, 0, −1 − j, 0, 0, 0, −1 − j, 0, −1 − j, 0, −1 − j, 0, 1 + j, 0, | 2.0589 dB |
| 1 + j, 0, 1 + j} | |
| \sqrt{1/2} {−1 − j, 0, −1 − j, 0, −1 − j, 0, 1 + j, 0, 1 + j, 0, 1 + j, 0, 0, 0, 1 + j, 0, −1 − j, 0, 1 + j, 0, 1 + j, 0, | 2.0589 dB |
| −1 − j, 0, 1 + j} | |
| \sqrt{1/2} {1 + j, 0, 1 + j, 0, 1 + j, 0, 1 + j, 0, −1 − j, 0, −1 − j, 0, 0, 0, 1 + j, 0, −1 − j, 0, −1 − j, 0, 1 + j, 0, | 2.2394 dB |
| −1 − j, 0, 1 + j} | |
| \sqrt{1/2} {1 + j, 0, −1 − j, 0, 1 + j, 0, −1 − j, 0, −1 − j, 0, 1 + j, 0, 0, 0, −1 − j, 0, −1 − j, 0, 1 + j, 0, 1 + j, 0, | 2.2394 dB |
| 1 + j, 0, 1 + j} | |
| \sqrt{1/2} {−1 − j, 0, 1 + j, 0, −1 − j, 0, 1 + j, 0, 1 + j, 0, −1 − j, 0, 0, 0, 1 + j, 0, 1 + j, 0, −1 − j, 0, −1 − j, 0, | 2.2394 dB |
| −1 − j, 0, −1 − j} | |
| \sqrt{1/2} {−1 − j, 0, −1 − j, 0, −1 − j, 0, −1 − j, 0, 1 + j, 0, 1 + j, 0, 0, 0, −1 − j, 0, 1 + j, 0, 1 + j, 0, −1 − j, 0, | 2.2394 dB |
| 1 + j, 0, −1 − j} | |
| \sqrt{1/2} {1 + j, 0, 1 + j, 0, 1 + j, 0, 1 + j, 0, 1 + j, 0, −1 − j, 0, 0, 0, −1 − j, 0, 1 + j, 0, 1 + j, 0, −1 − j, 0, −1 − | 2.2974 dB |
| j, 0, 1 + j} | |
| \sqrt{1/2} {−1 − j, 0, −1 − j, 0, −1 − j, 0, −1 − j, 0, −1 − j, 0, 1 + j, 0, 0, 0, 1 + j, 0, −1 − j, 0, −1 − j, 0, 1 + j, 0, | 2.2974 dB |
| 1 + j, 0, −1 − j} | |

Accordingly, the STF sequences 512 of Table 26 may correspond to STF sequences with optimally low PAPR values for a 32-point FFT for the twenty-second allocation shown in FIG. 6. The STF sequences 512 may correspond to training sequences with low PAPR values when using a four times oversampled IFFT.

In another embodiment, LTF sequences 514 for the twenty-second allocation of FIG. 6 may be determined. Table 27 below shows LTF sequences optimized for low PAPR where the values for all the data and pilot subcarriers are chosen from either +1 or −1 in the spectral line of LTF_{-12:12}.

TABLE 27

| LTF_{-12:12} | PAPR |
|---|---|
| {1, 1, −1, −1, −1, −1, 1, 1, −1, 1, 1, −1, 0, 1, 1, 1, −1, 1, 1, −1, 1, −1, 1, −1, 1} | 1.8712 dB |
| {1, −1, −1, −1, 1, −1, −1, 1, 1, 1, 1, 1, 0, 1, −1, −1, 1, 1, 1, 1, −1, 1, −1, 1, 1} | 2.1749 dB |
| {1, 1, 1, 1, 1, 1, −1, −1, −1, 1, 1, 1, 0, −1, 1, 1, −1, 1, 1, −1, −1, 1, −1, 1, −1} | 2.1821 dB |
| {1, 1, 1, 1, −1, −1, −1, −1, −1, 1, −1, −1, 0, 1, −1, −1, −1, 1, −1, 1, −1, −1, 1, −1, 1} | 2.1847 dB |
| {1, −1, 1, −1, −1, −1, 1, 1, 1, −1, 1, 1, 0, 1, −1, −1, −1, 1, −1, −1, 1, −1, −1, −1, −1} | 2.2697 dB |
| {1, 1, −1, −1, −1, −1, −1, −1, −1, 1, 1, −1, 0, −1, −1, 1, 1, −1, 1, −1, 1, −1, 1, 1, −1} | 2.2899 dB |
| {1, 1, 1, 1, 1, −1, 1, 1, 1, 1, −1, −1, 0, −1, 1, −1, 1, −1, 1, 1, −1, −1, 1, 1, −1} | 2.3227 dB |
| {1, 1, 1, 1, 1, 1, −1, 1, −1, −1, −1, 1, 0, 1, 1, −1, 1, −1, −1, 1, 1, 1, −1, −1, 1} | 2.3775 dB |
| {1, 1, −1, −1, −1, 1, 1, 1, 1, 1, 1, −1, 0, −1, 1, −1, −1, −1, 1, −1, −1, 1, −1, −1, 1} | 2.3892 dB |
| {1, −1, −1, −1, 1, −1, −1, −1, 1, −1, 1, −1, 0, 1, −1, 1, −1, −1, 1, 1, 1, 1, 1, −1, −1} | 2.4027 dB |

Accordingly, the LTF sequences 514 of Table 27 may correspond to LTF sequences with optimally low PAPR values for a 32-point FFT for the twenty-second allocation shown in FIG. 6. The LTF sequences 514 may correspond to training sequences with low PAPR values when using a four times oversampled IFFT.

In another embodiment, LTF sequences 514 for the twenty-second allocation of FIG. 6 may be determined for use with single stream pilots. Table 28 below shows LTF sequences optimized for low PAPR where the values for all the data and pilot subcarriers are chosen from either +1 or −1 in the spectral line of LTF_{-12:12}, the pilot subcarriers have indices of −10, −3, +3 and +10 for the spectral line, and the LTF sequences are chose to minimize the maximal PAPR for all possible P and R values for up to 4 streams to transmit.

TABLE 28

| LTF_{-12:12} | PAPR |
|---|---|
| {1, 1, 1, −1, 1, −1, 1, −1, −1, 1, 1, −1, 0, −1, 1, −1, −1, 1, −1, −1, −1, −1, −1, 1, 1} | 3.0103 dB |
| {1, 1, 1, −1, 1, 1, 1, −1, −1, −1, −1, 1, 0, 1, −1, 1, −1, −1, 1, −1, 1, 1, −1, 1, 1} | 3.0490 dB |
| {1, 1, 1, 1, −1, −1, −1, −1, 1, 1, −1, −1, 0, 1, −1, 1, −1, 1, −1, 1, 1, −1, 1, 1, −1} | 3.1686 dB |
| {1, 1, 1, −1, 1, 1, 1, 1, −1, 1, −1, −1, 0, −1, 1, 1, 1, −1, 1, −1, −1, 1, 1, −1, 1} | 3.2108 dB |
| {1, 1, 1, −1, −1, −1, 1, −1, −1, −1, 1, −1, 0, 1, 1, −1, 1, 1, −1, 1, −1, 1, 1, 1, 1} | 3.2417 dB |
| {1, −1, 1, 1, −1, 1, 1, 1, 1, 1, 1, 1, 0, −1, −1, 1, −1, 1, −1, −1, −1, 1, 1, 1, −1} | 3.2441 dB |
| {1, 1, 1, 1, 1, −1, 1, 1, −1, 1, −1, −1, 0, 1, 1, 1, −1, −1, 1, −1, −1, −1, 1, 1, −1} | 3.2814 dB |
| {1, −1, 1, −1, −1, −1, −1, 1, −1, 1, 1, −1, 0, 1, 1, 1, 1, −1, 1, 1, −1, −1, 1, 1, 1} | 3.3017 dB |
| {1, 1, 1, −1, 1, −1, −1, 1, −1, 1, 1, −1, 0, 1, 1, −1, −1, −1, −1, −1, 1, −1, −1, −1, 1} | 3.3335 dB |
| {1, −1, 1, 1, −1, −1, −1, −1, 1, 1, 1, 1, 0, 1, 1, −1, 1, 1, −1, −1, −1, 1, −1, 1, −1} | 3.3523 dB |

Accordingly, the LTF sequences 514 of Table 28 may correspond to LTF sequences with optimally low PAPR values for a 32-point FFT for use with single stream pilots for the twenty-second allocation shown in FIG. 6. The LTF sequences 514 may correspond to training sequences with low PAPR values when using a four times oversampled IFFT.

While the description above describes STF sequences and LTF sequences 512 and 514 for the various allocations as shown in FIG. 6 and described above, it should be appreciated that STF sequences and LTF sequences that are optimized for low PAPR may also be generated for any of the other allocations according to the systems and methods described herein.

While the allocations described above with reference to FIG. 6 correspond to a 32-point FFT, training sequences may be developed for different FFT sizes. According to another embodiment, training sequences may be developed for a 64-point FFT implementation. For example a STF sequence may be optimized for low PAPR for a 64-point FFT. To differentiate 32-point FFT and 64-point FFT, two different periodicities may be used and detected. In one embodiment, for a 64-point FFT, there may be 7 guard subcarriers 1 DC subcarrier 606, 4 pilot subcarriers 610, and 52 data subcarriers. For the STF sequence, the subcarriers corresponding to the guard subcarriers and DC subcarrier may be modulated with a value of zero. The position of the guard subcarriers may be divided and be at the beginning and the end of the spectral line of subcarriers. A limited number of data or pilot subcarriers for the STF sequence 512 are chosen to be modulated with non-zero values. The spectral line for all non guard symbols may be from −28:28 To achieve a low PAPR, the values for modulating the non-zero value subcarriers may be chosen from:

$$\{ {e}^{\pm j \frac{π}{4}} = \pm \sqrt{\frac{1}{2}} ( 1 + j ) \}$$

and may correspond to indices that are a multiple of 8 in the spectral line of S_{-28:28} (i.e., populating every eighth tone with the exception of the DC tone). The two values of \sqrt{½}(1+j) and \sqrt{½}(−1−j) may correspond to values that provide improved correlation for the detection of the presence of a packet while also additionally providing a value to allow a reduced PAPR for the STF sequence 512. Repeating non-zero values (e.g., ensuring the sequence has periodicity) and ensuring that there are an equal number of non-zero values on each side of the DC value provides good correlation and helps with packet detection. The values in Table 29 below shows short training sequences 512, according to certain embodiments, that have been determined to have low PAPR values using the choice of symbols as just described according to a 64-point size FFT.

TABLE 29

| S_{-13:13} | PAPR |
|---|---|
| \sqrt{1/2} {0, 0, 0, 0, 1 + j, 0, 0, 0, 0, 0, 0, 0, −1 − j, 0, 0, 0, 0, 0, 0, 0, 1 + j, 0, 0, 0, 0, 0, 0, 0, 0, 0, 0, 0, 0, 0, 0, 0, −1 − | 2.2303 dB |
| j, 0, 0, 0, 0, 0, 0, 0, −1 − j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, 1 + j, 0, 0, 0, 0, 0, 0, 0, −1 − | 2.2303 dB |
| j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, −1 − | 2.2303 dB |
| j, 0, 0, 0, 0, 0, 0, 0, 1 + j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, −1 − j, 0, 0, 0, 0, 0, 0, 0, −1 − | 2.2303 dB |
| j, 0, 0, 0, 0, 0, 0, 0, 0, 0, 0, 0, 0, 0, 0, 0, 1 + j, 0, 0, 0, 0, 0, 0, 0, −1 − j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, −1 − j, 0, 0, 0, 0, 0, 0, 0, 0, 0, 0, 0, 0, 0, 0, 0, −1 − | 3.3095 dB |
| j, 0, 0, 0, 0, 0, 0, 0, −1 − j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, −1 − j, 0, 0, 0, 0, 0, 0, 0, −1 − j, 0, 0, 0, 0, 0, 0, 0, 0, 0, 0, 0, 0, 0, 0, 0, −1 − | 3.3095 dB |
| j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, −1 − | 3.3095 dB |
| j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, 1 + j, 0, 0, 0, 0, 0, 0, 0, −1 − | |
| j, 0, 0, 0, 0, 0, 0, 0, −1 − j, 0, 0, 0, 0} | |
| \sqrt{1/2} {0, 0, 0, 0, −1 − j, 0, 0, 0, 0, 0, 0, 0, −1 − | 3.3095 dB |
| j, 0, 0, 0, 0, 0, 0, 0, 1 + j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, −1 − | |
| j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, 1 + j, 0, 0, 0, 0, 0, 0, 0, 0, 0, 0, 0, 0, 0, 0, 0, −1 − | 4.2597 dB |
| j, 0, 0, 0, 0, 0, 0, 0, 1 + j, 0, 0, 0, 0, 0, 0, 0, 1 + j, 0, 0, 0, 0} | |
| \sqrt{1/2} {0, 0, 0, 0, 1 + j, 0, 0, 0, 0, 0, 0, 0, 1 + j, 0, 0, 0, 0, 0, 0, 0, −1 − | 4.2597 dB |
| j, 0, 0, 0, 0, 0, 0, 0, 0, 0, 0, 0, 0, 0, 0, 0, 1 + j, 0, 0, 0, 0, 0, 0, 0, 1 + j, 0, 0, 0, 0, 0, 0, 0, 1 + j, 0, 0, 0, 0} | |

Accordingly, these STF sequences may correspond to optimally low PAPR values that may avoid distorting the short training sequence when transmitted while having good correlation properties for packet detection for a 64-point FFT. These sequences may correspond to training sequence with low PAPR values when using a four times oversampled IFFT.

### FFT Size Detection

As discussed above with respect to FIGS. 2 and 3, the wireless device 202a can be configured to operate in various FFT modes. In various embodiments, the wireless device 202a can be configured to use a 64-point FFT size in conjunction with a higher-bandwidth channel than the 32-point FFT channel. For example, the 64-point FFT channel can have twice the bandwidth of the 32-point FFT channel. In an embodiment, the IFFT 304 can be configured to use a 64-point FFT size in conjunction with a 2 MHz channel, and the IFFT 304 can be configured to use a 32-point FFT channel can be a 1 MHz channel. In an embodiment, the IFFT 304 can be configured to selectively use a plurality of different FFT sizes. In another embodiment, a plurality of different IFFTs can each be configured to use a different FFT size, the output of which can be selectively routed to the DAC 306.

As discussed above with respect to FIG. 5, the processor 204 can be configured to indicate the FFT size in the STF 512 (FIG. 5). For example, in the 32-point FFT mode, the processor 204 can populate every fourth available tone of each OFDM symbol in the STF with a complex value, leaving the other tones empty. In an embodiment, empty tones are assigned a value of 0. When the IFFT 304 translates the STF tones into the time domain, this results in a 4-time repetition of a short training symbol within each OFDM symbol (excluding a cycle prefix). In embodiments where the 32-point FFT mode is used in conjunction with a 1 MHz bandwidth, each copy of the short training symbol will by 8 samples long (sampled at the Nyquist rate).

In an embodiment, in the 64-point FFT mode, the processor 204 can populate every eight available tone of each OFDM symbol in the STF with a complex value, leaving the other tones empty. In an embodiment, empty tones are assigned a value of 0. When the IFFT 304 translates the STF tones into the time domain, this results in an 8-time repetition of a short training symbol within each OFDM symbol (excluding a cycle prefix). In embodiments where the 64-point FFT mode is used in conjunction with a 2 MHz bandwidth, each copy of the short training symbol will by 8 samples long (sampled at the Nyquist rate). In other words, in embodiments where the 32-point FFT mode corresponds with a 1 MHz bandwidth, and the 64-point FFT mode corresponds with a 2 MHz bandwidth, the processor 204 can populate the tones of each OFDM symbol in the STF sufficient for the short training symbol to be the same length in each mode.

With respect to FIGS. 2 and 4, in an aspect, the wireless device 202b can be configured to detect the FFT size of a transmission based on the STF encoded with the short training symbol. The packet detector 403 can be configured to differentiate transmissions of different FFT sizes based on the length of the short training symbol in the STF. In the aforementioned embodiment, where the 32-point FFT mode has a 4-time repetition of the short training symbol at 1 MHz, and the 64-point FFT mode has an 8-time repetition of the short training symbol at 2 MHz, the ODFM symbol duration for both FFT modes will be 32 μs. Because the 32-point mode short training symbol is one-fourth of an OFDM symbol, it will be 8 μs long. Similarly, the 64-point FFT mode short training symbol is one-eighth of an ODFM symbol. Accordingly, the 64-point FFT mode short training symbol is 4 μs long.

Accordingly, the packet detector 403 can be configured to detect 64-point FFT mode packets by measuring the auto-correlation of the received STF with a shift of 4 μs. Similarly, the packet detector 403 can be configured to detect 32-point FFT mode packets by measuring the auto-correlation of the received STF with a shift of 8 μs. In an embodiment, the packet detector 403 can relay the detected FFT size to the FFT module 404.

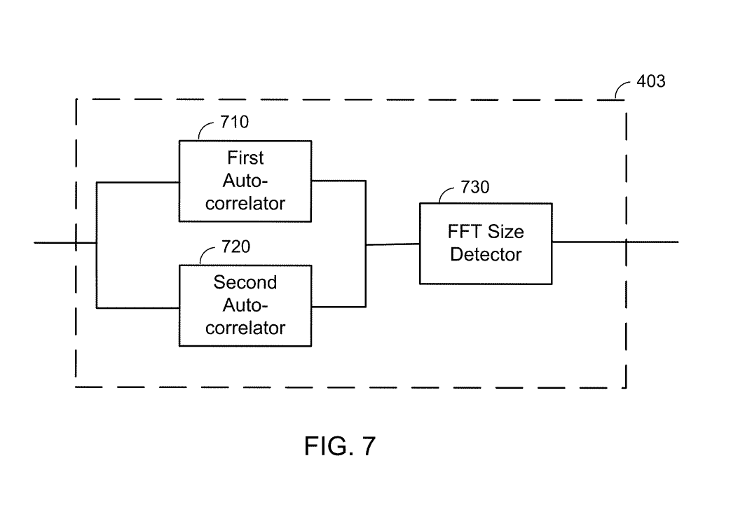

FIG. 7 shows a functional block diagram of exemplary components that may be utilized in the packet detector 403 of FIG. 4. In the illustrated embodiment, the packet detector 403 includes a first auto-correlator 710, a second auto-correlator 720, and an FFT size detector 730. The first auto-correlator 710 is configured to measure the auto-correlation of an incoming transmission using a first shift length. In an embodiment, the first shift length can be 8 μs. In an embodiment, the first auto-correlator 710 is configured to delay the incoming transmission by 8 μs and to measure correlation of the delayed transmission with an un-delayed transmission. The auto-correlator 710 may be configured to output a raw auto-correlation value, or to compare the raw auto-correlation value to a threshold value and to output a signal indicating whether the raw auto-correlation value surpasses the threshold. In embodiments where the STF of a 32-point FFT mode packet includes an 8 μs short training symbol, the auto-correlator 710 can be configured to detect the 32-point FFT mode when auto-correlation is above the threshold using an 8 μs shift length.

In the illustrated embodiment, the second auto-correlator 720 is configured to measure the auto-correlation of an incoming transmission using a second shift length. In an embodiment, the second shift length can be half the first shift length. In an embodiment, the second shift length can be 4 μs. In an embodiment, the second auto-correlator 720 is configured to delay the incoming transmission by 4 μs and to measure correlation of the delayed transmission with an un-delayed transmission. The auto-correlator 720 may be configured to output a raw auto-correlation value, or to compare the raw auto-correlation value to a threshold value and to output a signal indicating whether the raw auto-correlation value surpasses the threshold. In embodiments where the STF of a 64-point FFT mode packet includes a 4 μs short training symbol, the auto-correlator 720 can be configured to detect the 64-point FFT mode when auto-correlation is above the threshold using a 4 μs shift length.

In an embodiment, the first and second auto-correlators 710 and 720 can be configured to indicate the auto-correlation of a transmission the FFT size detector 730, using a plurality of shift lengths. The FFT size detector 730 can be configured to interpret the auto-correlation of the transmission as an FFT size based on the auto-correlation indications received from the auto-correlators 710 and 720. For example, if the first auto-correlator 710 indicates that a received transmission has a relatively high auto-correlation using an 8 μs shift length, and the second auto-correlator 720 indicates that the transmission has a relatively low auto-correlation using a 4 μs shift length, the FFT size detector 730 may determine that the incoming transmission uses a 32-point FFT size. The FFT size detector 730 may then output a signal indicating that it has detected a 32-point FFT packet.

As another example, if the first auto-correlator 710 indicates that the received transmission has a relatively low auto-correlation using an 8 μs shift length, and the second auto-correlator 720 indicates that the transmission has a relatively high auto-correlation using a 4 μs shift length, the FFT size detector 730 may determine that the incoming transmission uses 64-point FFT size. The FFT size detector 730 may then output a signal indicating that it has detected a 64-point FFT packet. As another example, if the first auto-correlator 710 indicates that the received transmission has a relatively low auto-correlation using an 8 μs shift length, and the second auto-correlator 720 indicates that the transmission has a relatively low auto-correlation using a 4 μs shift length, the FFT size detector 730 may determine that the incoming transmission is not the start of a packet.

As another example, if the first auto-correlator 710 indicates that the received transmission has a relatively high auto-correlation using an 8 μs shift length, and the second auto-correlator 720 indicates that the transmission has a relatively high auto-correlation using a 4 μs shift length, the FFT size detector 730 may determine that the incoming transmission uses 64-point FFT size. The FFT size detector 730 may then output a signal indicating that it has detected a 64-point FFT packet.

In an embodiment, the processor 204 (FIG. 2) of the wireless device 202a can be configured to populate a 32-point FFT mode STF with non-zero values sufficient for low auto-correlation when using a shift length of half the periodicity of the short 32-point FFT training symbol. For example, the processor 204 may be configured to populate the 32-point FFT mode STF with non-zero values every fourth tone sufficient to create zero auto-correlation using a 4 μs shift length. Examples of such STF values are discussed above, for example, with respect to Table 1. Accordingly, the second auto-correlator 720 may not trigger when receiving a 32-point FFT packet.

As discussed above, however, the processor 204 of the wireless device 202a may be configured to populate a 64-point FFT mode STF with non-zero values every eight tone sufficient to create zero auto-correlation using an 8 μs shift length. Examples of such STF values are discussed above, for example, with respect to Table 29. Therefore, both the first auto-correlator 710 and the second auto-correlator 720 may trigger when receiving a 64-point FFT packet. Accordingly, the FFT size detector 730 may be configured to interpret a trigger from both the first and second auto-correlators 710 and 720 as the detection of a 64-point FFT packet. The FFT size detector 730 may then output a signal indicating that it has detected a 64-point FFT packet.

Although the first and second auto-correlators 710 and 720 are discussed above with respect to 32-point and 64-point FFT sizes, respectively, a person having ordinary skill in the art will appreciate that additional auto-correlators can be used to detect addition FFT sizes, fewer FFT sizes, or different FFT sizes. In general, an auto-correlator can be configured to detect an X-point FFT packet by auto-correlating a received signal using a shift equal to the periodicity of the short training symbol for the X-point FFT packet. In an embodiment, the periodicity of the short training symbol for an X-point FFT packet will be X divided by the bandwidth of the signal.

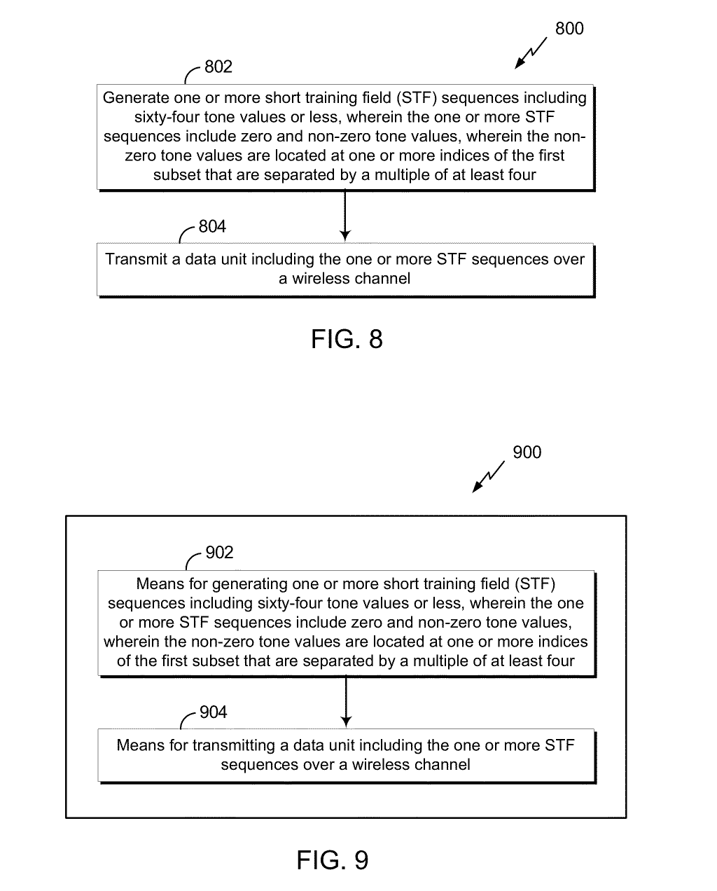

FIG. 8 is a flowchart 800 illustrating an embodiment of a method of generating and transmitting a data unit. The method 800 may be used to generate any of the data units and STF sequences 512 described above. The data units may be generated at either the AP 104 or the STA 106 and transmitted to another node in the wireless network 100. Although the method 800 is described below with respect to elements of the wireless device 202a (FIG. 2), those having ordinary skill in the art will appreciate that other components may be used to implement one or more of the steps described herein. In an embodiment, the steps in the flowchart 800 may be performed, at least in part, by a processor or controller such as, for example, the processor 204 (FIG. 2) and/or the DSP 220 (FIG. 2), potentially in conjunction with the memory 206 (FIG. 2). Although blocks may be described as occurring in a certain order, the blocks can be reordered, blocks can be omitted, and/or additional blocks can be added.

First, at block 802, the processor 204 generates one or more short training field (STF) sequences 512 including sixty-four tone values or less. As described above with respect to Table 29, the one or more STF sequences include zero and non-zero tone values, and the non-zero tone values are located at indices of the first subset that are a multiple of eight. In an embodiment, the modulator 302 may modulate the transmission, and the IFFT 304 may translate the tones in the STF into the time domain.

Then, at block 804, the transmitter 210 transmits a data unit including the one or more STF sequences 512 over a wireless channel. The transmitter 210 can transmit the data unit via the antenna 216. The wireless channel can include the uplink 110.

FIG. 9 is a functional block diagram of a system 900 for wireless communication. Those skilled in the art will appreciate that a system for wireless communication may have more components than the simplified system 900 shown in FIG. 9. The system 900 shown includes only those components useful for describing some prominent features of implementations within the scope of the claims. The system 900 for wireless communication includes means 902 for generating one or more short training field (STF) sequences including sixty-four tone values or less, and means 904 for transmitting a data unit including the one or more STF sequences over a wireless channel.

In an embodiment, the means 902 for generating one or more short training field (STF) sequences including sixty-four tone values or less can be configured to perform one or more of the functions described above with respect to block 802 (FIG. 8). In various embodiments, the means 902 for generating one or more short training field (STF) sequences including sixty-four tone values or less can be implemented by one or more of the processor 204 (FIG. 2), the memory 206 (FIG. 2), and the DSP 220 (FIG. 2).

In an embodiment, the means 904 for transmitting a data unit including the one or more STF sequences over a wireless channel can be configured to perform one or more of the functions described above with respect to block 802 (FIG. 8). In various embodiments, the means 904 for transmitting a data unit including the one or more STF sequences over a wireless channel can be implemented by one or more of the processor 204 (FIG. 2), the memory 206 (FIG. 2), the DSP 220 (FIG. 2), and the transmitter 210 (FIG. 2).

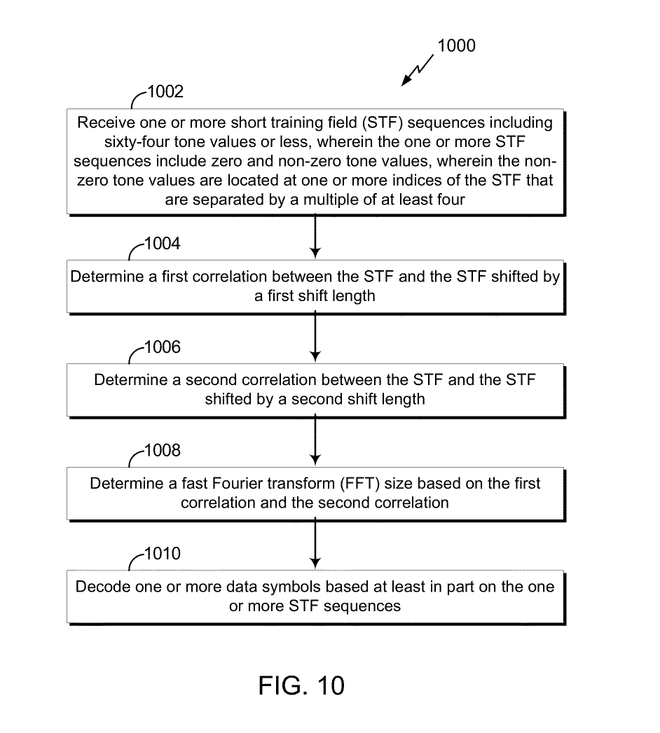

FIG. 10 is a flowchart 1000 illustrating an embodiment of a method of wireless communication. The method 1000 may be used to receive any of the data units described above. The packets may be received at either the AP 104 or the STA 106 from another node in the wireless network 100. Although the method 1000 is described below with respect to elements of the wireless device 202b (FIG. 2), those having ordinary skill in the art will appreciate that other components may be used to implement one or more of the steps described herein. In an embodiment, the steps in the flowchart 800 may be performed, at least in part, by a processor or controller such as, for example, the processor 204 (FIG. 2) and/or the DSP 220 (FIG. 2), potentially in conjunction with the memory 206 (FIG. 2). Although blocks may be described as occurring in a certain order, the blocks can be reordered, blocks can be omitted, and/or additional blocks can be added.

First, at block 1002, the receiver 212 receives one or more short training field (STF) sequences comprising sixty-four tone values or less. As described above with respect to Table 29, the one or more STF sequences comprise zero and non-zero tone values, and the non-zero tone values are located at indices of the first subset that are a multiple of eight. Next, at block 1004, the first auto-correlator 710 (FIG. 7) in the packet detector 403 (FIG. 4) determines a first correlation between the STF and the STF shifted by a first shift length. In an embodiment, first shift length corresponds to a periodicity of a short training symbol for a 32-point FFT STF. In another embodiment, the first shift length is 8 μs.

Then, at block 1006, the second auto-correlator 720 determines a second correlation between the STF and the STF shifted by a second shift length. In an embodiment, the first shift length is double the second shift length. In another embodiment, the second shift length corresponds to a periodicity of a short training symbol for a 64-point FFT STF. In one embodiment, the second shift length is 4 μs. In various embodiments, the FFT size detector 730 can be implemented by one or more of the processor 204, the signal detector 218, and the DSP 220.

Subsequently, at block 1008, the FFT size detector 730 in the packet detector 403 determines a fast Fourier transform (FFT) size based on the first correlation and the second correlation. In an embodiment, if a 4 μs shift length results in a high auto-correlation, the FFT size detector 730 outputs an indication that the transmission uses a 64-point FFT. If an 8 μs shift length results in a high auto-correlation, the FFT size detector 730 outputs an indication that the transmission uses a 32-point FFT. In various embodiments, the FFT size detector 730 can be implemented by one or more of the processor 204, the signal detector 218, and the DSP 220.

Finally, at block 1010, the FFT 404 decodes one or more data symbols based at least in part on the determined FFT size. In an embodiment, the FFT 404 decodes the data symbols using an FFT size received from the FFT size detector 730. In various embodiments, the FFT size detector 730 can be implemented by one or more of the processor 204, the signal detector 218, and the DSP 220.

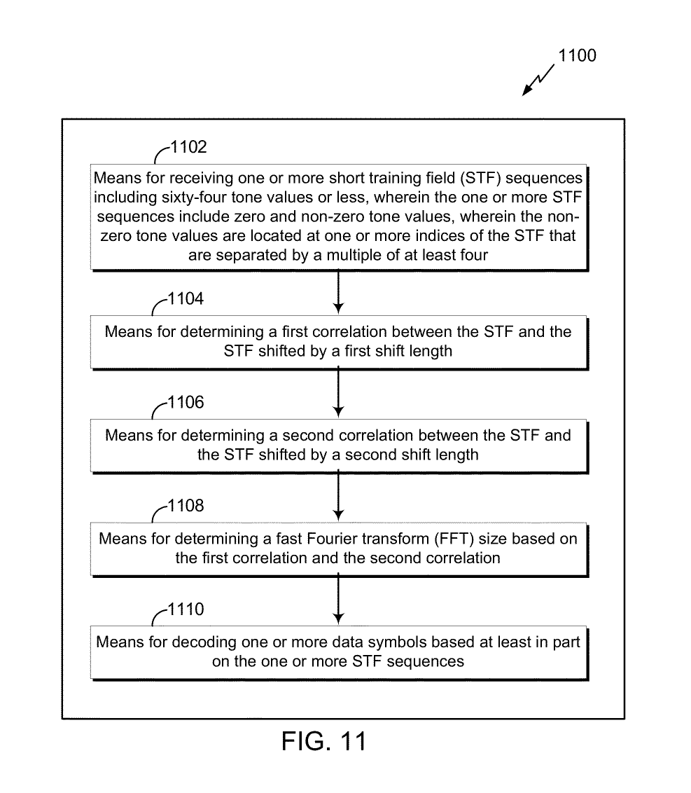

FIG. 11 is a functional block diagram of a system 1100 for wireless communication. Those skilled in the art will appreciate that a system for wireless communication may have more components than the simplified system 1100 shown in FIG. 11. The system 1100 shown includes only those components useful for describing some prominent features of implementations within the scope of the claims.

The system 1100 for wireless communication includes means 1102 for receiving one or more short training field (STF) sequences including sixty-four tone values or less, means 1104 for or determining a first correlation between the STF and the STF shifted by a first shift length, means 1106 for determining a second correlation between the STF and the STF shifted by a second shift length, means 1108 for determining a fast Fourier transform (FFT) size based on the first correlation and the second correlation, and means 1110 for decoding one or more data symbols based at least in part on the one or more STF sequences.

In an embodiment, the means 1102 for receiving one or more short training field (STF) sequences including sixty-four tone values or less can be configured to perform one or more of the functions described above with respect to block 1102 (FIG. 10). In various embodiments, the means 1102 for receiving one or more short training field (STF) sequences including sixty-four tone values or less can be implemented by one or more of the processor 204 (FIG. 2), the memory 206 (FIG. 2), the DSP 220 (FIG. 2), and the receiver 212 (FIG. 2).

In an embodiment, the means 1104 for or determining a first correlation between the STF and the STF shifted by a first shift length can be configured to perform one or more of the functions described above with respect to block 1104 (FIG. 10). In various embodiments, the means 1104 for or determining a first correlation between the STF and the STF shifted by a first shift length can be implemented by one or more of the processor 204 (FIG. 2), the memory 206 (FIG. 2), the packet detector 403 (FIG. 4), the first auto-correlator 710 (FIG. 7), and the DSP 220 (FIG. 2).

In an embodiment, the means 1106 for determining a second correlation between the STF and the STF shifted by a second shift length can be configured to perform one or more of the functions described above with respect to block 1106 (FIG. 10). In various embodiments, the means 1106 for determining a second correlation between the STF and the STF shifted by a second shift length can be implemented by one or more of the processor 204 (FIG. 2), the memory 206 (FIG. 2), the packet detector 403 (FIG. 4), the second auto-correlator 720 (FIG. 7), and the DSP 220 (FIG. 2).

In an embodiment, the means 1108 for determining a fast Fourier transform (FFT) size based on the first correlation and the second correlation can be configured to perform one or more of the functions described above with respect to block 1108 (FIG. 10). In various embodiments, the means 1108 for determining a fast Fourier transform (FFT) size based on the first correlation and the second correlation can be implemented by one or more of the processor 204 (FIG. 2), the memory 206 (FIG. 2), the packet detector 403 (FIG. 4), the FFT size detector 730 (FIG. 7), and the DSP 220 (FIG. 2).

In an embodiment, the means 1110 for decoding one or more data symbols based at least in part on the one or more STF sequences can be configured to perform one or more of the functions described above with respect to block 1110 (FIG. 10). In various embodiments, the means 1110 for decoding one or more data symbols based at least in part on the one or more STF sequences can be implemented by one or more of the processor 204 (FIG. 2), the memory 206 (FIG. 2), the packet detector 403 (FIG. 4), the demodulator 406 (FIG. 4), the channel estimator and equalizer 405 (FIG. 4), the FFT 404 (FIG. 4), and the DSP 220 (FIG. 2).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, β-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
receiving one or more short training field (STF) sequences comprising sixty-four tone values or less, wherein the one or more STF sequences comprise zero and non-zero tone values, wherein the non-zero tone values are located at one or more indices of the STF that are a separated by a multiple of at least four;
determining a first correlation between the STF and the STF shifted by a first shift length;
determining a second correlation between the STF and the STF shifted by a second shift length;
determining a fast Fourier transform (FFT) size based on the first correlation and the second correlation; and
decoding one or more data symbols based at least in part on the determined FFT size.

2. The method of claim 1, wherein the first shift length is double the second shift length.

3. The method of claim 1, wherein the first shift length corresponds to a periodicity of a short training symbol for a 32-point FFT STF.

4. The method of claim 3, wherein the first shift length is one fourth of the duration of an OFDM symbol.

5. The method of claim 3, wherein the first shift length is 8 μs.

6. The method of claim 1, wherein the second shift length corresponds to a periodicity of a short training symbol for a 64-point FFT STF.

7. The method of claim 6, wherein the second shift length is one eight of the duration of an OFDM symbol.

8. The method of claim 6, wherein the second shift length is 4 μs.

9. The method of claim 1, wherein the non-zero tone values comprise complex numbers.

10. The method of claim 1, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

11. The method of claim 1, further comprising receiving the STF over a channel having a bandwidth of 1 MHz.

12. The method of claim 1, wherein the non-zero tone values are located at indices of the STF that are a multiple of four.

13. The method of claim 1, further comprising receiving the STF over a channel having a bandwidth of 2 MHz.

14. The method of claim 1, wherein the non-zero tone values are located at indices of the STF that are a multiple of eight.

15. The method of claim 14, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

16. The method of claim 1, wherein each value in the one or more STF sequences corresponds to one of a guard subcarrier, a direct current subcarrier, a data subcarrier, and a pilot subcarrier of a signal.

17. The method of claim 16, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

18. A method of wireless communication, comprising:
generating one or more short training field (STF) sequences comprising sixty-four tone values or less, wherein the one or more STF sequences comprise zero and non-zero tone values, wherein the non-zero tone values are located at indices of the first subset that are a multiple of eight; and
transmitting a data unit comprising the one or more STF sequences over a wireless channel.

19. The method of claim 18, wherein generating one or more short training field (STF) sequences comprise generating one or more STF sequences for use with an extended range mode.

20. The method of claim 18, wherein the non-zero tone values comprise complex numbers.

21. The method of claim 18, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

22. The method of claim 18, further comprising transmitting the STF over a channel having a bandwidth of 1 MHz.

23. The method of claim 18, wherein the non-zero tone values are located at indices of the STF that are a multiple of four.

24. The method of claim 18, further comprising transmitting the STF over a channel having a bandwidth of 2 MHz.

25. The method of claim 18, wherein the non-zero tone values are located at indices of the STF that are a multiple of eight.

26. The method of claim 25, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

27. The method of claim 18, wherein each value in the one or more STF sequences corresponds to one of a guard subcarrier, a direct current subcarrier, a data subcarrier, and a pilot subcarrier of a signal.

28. The method of claim 27, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

29. A wireless device comprising:
a receiver configured to receive one or more short training field (STF) sequences comprising sixty-four tone values or less, wherein the one or more STF sequences comprise zero and non-zero tone values, wherein the non-zero tone values are located at one or more indices of the STF that are separated by a multiple of at least four; and
a processor configured to:
determine a first correlation between the STF and the STF shifted by a first shift length;
determine a second correlation between the STF and the STF shifted by a second shift length;
determine a fast Fourier transform (FFT) size based on the first correlation and the second correlation; and
decode one or more data symbols based at least in part on the determined FFT size.

30. The wireless device of claim 29, wherein the first shift length is double the second shift length.

31. The wireless device of claim 29, wherein the first shift length corresponds to a periodicity of a short training symbol for a 32-point FFT STF.

32. The wireless device of claim 31, wherein the first shift length is one-fourth the duration of an OFDM symbol.

33. The wireless device of claim 31, wherein the first shift length is 8 μs.

34. The wireless device of claim 29, wherein the second shift length corresponds to a periodicity of a short training symbol for a 64-point FFT STF.

35. The wireless device of claim 34, wherein the second shift length is one-eighth the duration of an ODFM symbol.

36. The wireless device of claim 34, wherein the second shift length is 4 μs.

37. The wireless device of claim 29, wherein the non-zero tone values comprise complex numbers.

38. The wireless device of claim 29, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

39. The wireless device of claim 29, wherein the receiver is configured to receive the STF over a channel having a bandwidth of 1 MHz.

40. The wireless device of claim 29, wherein the non-zero tone values are located at indices of the STF that are a multiple of four.

41. The wireless device of claim 29 wherein the receiver is configured to receive the STF over a channel having a bandwidth of 2 MHz.

42. The wireless device of claim 29, wherein the non-zero tone values are located at indices of the STF that are a multiple of eight.

43. The wireless device of claim 42, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

44. The wireless device of claim 29, wherein each value in the one or more STF sequences corresponds to one of a guard subcarrier, a direct current subcarrier, a data subcarrier, and a pilot subcarrier of a signal.

45. The wireless device of claim 44, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

46. A wireless device comprising:
a processor configured to generate one or more short training field (STF) sequences comprising sixty-four tone values or less, wherein the one or more STF sequences comprise zero and non-zero tone values, wherein the non-zero tone values are located at indices of the first subset that are a multiple of eight; and
a transmitter configured to transmit a data unit comprising the one or more STF sequences over a wireless channel.

47. The wireless device of claim 46, wherein the processor is further configured to generate the one or more STF sequences for use with an extended range mode.

48. The wireless device of claim 46, wherein the non-zero tone values comprise complex numbers.

49. The wireless device of claim 46, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

50. The wireless device of claim 46, wherein the transmitter is configured to transmit the STF over a channel having a bandwidth of 1 MHz.

51. The wireless device of claim 46, wherein the processor is configured to generate non-zero tone values at indices of the STF that are a multiple of four.

52. The wireless device of claim 46, wherein the transmitter is configured to transmit the STF over a channel having a bandwidth of 2 MHz.

53. The wireless device of claim 46, wherein the processor is configured to generate non-zero tone values at indices of the STF that are a multiple of eight.

54. The wireless device of claim 53, wherein the processor is configured to generate a subset of the STF tone values corresponding to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

55. The wireless device of claim 46, wherein the processor is configured to generate each value in the one or more STF sequences to correspond to one of a guard subcarrier, a direct current subcarrier, a data subcarrier, and a pilot subcarrier of a signal.

56. The wireless device of claim 55, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

57. An apparatus for wireless communication, comprising:
means for receiving one or more short training field (STF) sequences comprising sixty-four tone values or less, wherein the one or more STF sequences comprise zero and non-zero tone values, wherein the non-zero tone values are located at one or more indices of the STF that are separated by a multiple of at least four;
means for determining a first correlation between the STF and the STF shifted by a first shift length;
means for determining a second correlation between the STF and the STF shifted by a second shift length;
means for determining a fast Fourier transform (FFT) size based on the first correlation and the second correlation; and
means for decoding one or more data symbols based at least in part on the determined FFT size.

58. The apparatus of claim 57, wherein the first shift length is double the second shift length.

59. The apparatus of claim 57, wherein the first shift length corresponds to a periodicity of a short training symbol for a 32-point FFT STF.

60. The apparatus of claim 59, wherein the first shift length is one-fourth the duration of an ODFM symbol.

61. The apparatus of claim 59, wherein the first shift length is 8 μs.

62. The apparatus of claim 57, wherein the second shift length corresponds to a periodicity of a short training symbol for a 64-point FFT STF.

63. The apparatus of claim 62, wherein the second shift length is one-eighth the duration of an OFDM symbol.

64. The apparatus of claim 62, wherein the second shift length is 4 μs.

65. The apparatus of claim 57, wherein the non-zero tone values comprise complex numbers.

66. The apparatus of claim 57, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

67. The apparatus of claim 57, further comprising means for receiving the STF over a channel having a bandwidth of 1 MHz.

68. The apparatus of claim 57, wherein the non-zero tone values are located at indices of the STF that are a multiple of four.

69. The apparatus of claim 57, further comprising means for receiving the STF over a channel having a bandwidth of 2 MHz.

70. The apparatus of claim 57, wherein the non-zero tone values are located at indices of the STF that are a multiple of eight.

71. The apparatus of claim 70, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

72. The apparatus of claim 57, wherein each value in the one or more STF sequences corresponds to one of a guard subcarrier, a direct current subcarrier, a data subcarrier, and a pilot subcarrier of a signal.

73. The apparatus of claim 72, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

74. An apparatus for wireless communication, comprising:
means for generating one or more short training field (STF) sequences comprising sixty-four tone values or less, wherein the one or more STF sequences comprise zero and non-zero tone values, wherein the non-zero tone values are located at indices of the first subset that are a multiple of eight; and
means for transmitting a data unit comprising the one or more STF sequences over a wireless channel.

75. The apparatus of claim 74, wherein means for generating one or more short training field (STF) sequences comprise means for generating one or more STF sequences for use with an extended range mode.

76. The apparatus of claim 74, wherein the non-zero tone values comprise complex numbers.

77. The apparatus of claim 74, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

78. The apparatus of claim 74, further comprising means for transmitting the STF over a channel having a bandwidth of 1 MHz.

79. The apparatus of claim 74, wherein the non-zero tone values are located at indices of the STF that are a multiple of four.

80. The apparatus of claim 74, further comprising means for transmitting the STF over a channel having a bandwidth of 2 MHz.

81. The apparatus of claim 74, wherein the non-zero tone values are located at indices of the STF that are a multiple of eight.

82. The apparatus of claim 81, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

83. The apparatus of claim 74, wherein each value in the one or more STF sequences corresponds to one of a guard subcarrier, a direct current subcarrier, a data subcarrier, and a pilot subcarrier of a signal.

84. The apparatus of claim 83, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

85. A non-transitory computer-readable medium comprising code that, when executed, causes an apparatus to:
receive one or more short training field (STF) sequences comprising sixty-four tone values or less, wherein the one or more STF sequences comprise zero and non-zero tone values, wherein the non-zero tone values are located at one or more indices of the STF that are separated by a multiple of at least four;
determine a first correlation between the STF and the STF shifted by a first shift length;
determine a second correlation between the STF and the STF shifted by a second shift length;
determine a fast Fourier transform (FFT) size based on the first correlation and the second correlation; and
decode one or more data symbols based at least in part on the determined FFT size.

86. The medium of claim 85, wherein the first shift length is double the second shift length.

87. The medium of claim 85, wherein the first shift length corresponds to a periodicity of a short training symbol for a 32-point FFT STF.

88. The medium of claim 87, wherein the first shift length is one-fourth the duration of an OFDM symbol.

89. The medium of claim 87, wherein the first shift length is 8 μs.

90. The medium of claim 85, wherein the second shift length corresponds to a periodicity of a short training symbol for a 64-point FFT STF.

91. The medium of claim 90, wherein the second shift length is one-eighth the duration of an OFDM symbol.

92. The medium of claim 90, wherein the second shift length is 4 μs.

93. The medium of claim 85, wherein the non-zero tone values comprise complex numbers.

94. The medium of claim 85, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

95. The medium of claim 85, further comprising code that, when executed, causes the apparatus to receive the STF over a channel having a bandwidth of 1 MHz.

96. The medium of claim 85, wherein the non-zero tone values are located at indices of the STF that are a multiple of four.

97. The medium of claim 85, further comprising code that, when executed, causes the apparatus to receive the STF over a channel having a bandwidth of 2 MHz.

98. The medium of claim 85, wherein the non-zero tone values are located at indices of the STF that are a multiple of eight.

99. The medium of claim 98, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

100. The medium of claim 85, wherein each value in the one or more STF sequences corresponds to one of a guard subcarrier, a direct current subcarrier, a data subcarrier, and a pilot subcarrier of a signal.

101. The medium of claim 100, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.

102. A non-transitory computer-readable medium for wireless communication comprising code that, when executed, causes an apparatus to:
generate one or more short training field (STF) sequences comprising sixty-four tone values or less, wherein the one or more STF sequences comprise zero and non-zero tone values, wherein the non-zero tone values are located at indices of the first subset that are a multiple of eight; and
transmit a data unit comprising the one or more STF sequences over a wireless channel.

103. The medium of claim 102, further comprising code that, when executed, causes the apparatus to generate the one or more STF sequences for use with an extended range mode.

104. The medium of claim 102, wherein the non-zero tone values comprise complex numbers.

105. The medium of claim 102, wherein the non-zero tone values comprise either a value of one plus the imaginary unit multiplied by the square root of one-half (+\sqrt{½}(1+j)) or a value of one plus the imaginary unit multiplied by the negative square root of one-half (−\sqrt{½}(1+j)).

106. The medium of claim 102, comprising code that, when executed, causes the apparatus to transmit the STF over a channel having a bandwidth of 1 MHz.

107. The medium of claim 102, wherein the non-zero tone values are located at indices of the STF that are a multiple of four.

108. The medium of claim 102, comprising code that, when executed, causes the apparatus to transmit the STF over a channel having a bandwidth of 2 MHz.

109. The medium of claim 102, wherein the non-zero tone values are located at indices of the STF that are a multiple of eight.

110. The medium of claim 109, wherein a subset of the STF tone values correspond to indices in a range from −28 to +28, and wherein the first subset of value comprises tone values of a square root of one half multiplied 0, 0, 0, 0, ±1±j, 0, 0, 0, 0, 0, 0, 0, ±1±j, 0, 0, 0, 0, 0, 0, 0, ±1±j, 0, 0, 0, 0, 0, 0, 0, 0, 0, 0, 0, 0, 0, 0, 0, ±1±j, 0, 0, 0, 0, 0, 0, 0, ±1±j, 0, 0, 0, 0, 0, 0, 0, ±1±j, 0, 0, 0, and 0.

111. The medium of claim 102, wherein each value in the one or more STF sequences corresponds to one of a guard subcarrier, a direct current subcarrier, a data subcarrier, and a pilot subcarrier of a signal.

112. The medium of claim 111, wherein the one or more STF sequences comprise tone values corresponding to the direct current subcarrier, the data subcarrier, and the pilot subcarrier, wherein the tone values correspond to indices in a range from a negative number to a positive number, and wherein the direct current subcarrier has an index of zero.
